(19) United States
(12) Patent Application Publication
(10) Pub. No.: US 2026/0313315 A1
(43) Pub. Date: Oct. 8, 2026

(54) COMMUNICATION-AWARE ROUTING WITH APPLICATION PLANNING FOR VEHICLES

(71) Applicant: QUALCOMM Incorporated, San Diego, CA (US)

(72) Inventors: Guangyi Liu, Shanghai (CN); Dan Vassilovski, Del Mar, CA (US); Shuanshuan Wu, San Diego, CA (US); Hans Christian Peter Thiel, Oberaudorf (DE)

(21) Appl. No.: 19/481,783

(22) PCT Filed: Jun. 23, 2023
(86) PCT No.: PCT/CN2023/102006

§ 371 Date: Nov. 5, 2025

(51) Int. Cl. H04W 4/024; G01C 21/00; G01C 21/36; H04W 4/44

(52) U.S. Cl. CPC H04W 4/024; G01C 21/3667; G01C 21/3889; H04W 4/44

(57) ABSTRACT

This disclosure provides systems, methods, and devices for wireless communication that support communication-aware routing with application planning. Communication-aware routing with application planning of some examples generates one or more routes for traveling between locations with application planning by considering communication information and application utilization information with respect to traveling the route. One or more communication-aware routes with application planning may be provided, such as to a device of or associated with a vehicle, for choosing in travel between origination and destination points. Reservation/priority information regarding communication resources of a network node associated with at least one roadway of a communication-aware routing selection may be provided to the network node. Other aspects and features are also claimed and described.

### TECHNICAL FIELD

Aspects of the present disclosure relate generally to wireless communication systems, and more particularly, to communication-aware routing with application planning. Some features may enable and provide improved communications, including implementing communication resource reservation/priority in association with communication-aware routing, such as based on information regarding application utilization associated with a vehicle traveling a route.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as network nodes (or node Bs or base stations) that may support communication for a number of user equipments (UEs). A UE may communicate with a base station via downlink and uplink. The downlink (or forward link) refers to the communication link from the network node to the UE, and the uplink (or reverse link) refers to the communication link from the UE to the network node.

Applications related to autonomous driving and tele-operated driving, such as may rely upon transmission of messages for traffic conditions, road information, accidents, emergency vehicles, etc., represent one area in which the demand for mobile broadband access has increased. The use of various relatively high bandwidth applications, such as video streaming, virtual reality (VR), augmented reality (AR), etc., by users traveling in vehicles has continued to see increase and represents another area in which the demand for mobile broadband access has increased. The communication requirements of applications in these scenarios can place significant demand upon wireless networks, and may experience diminished communication quality and even interruptions in communication due to congestion and interference. Issues with respect to diminution in communication quality and interruptions experienced by applications in association with traveling vehicles may be exacerbated by the geographically non-uniform distribution of communication resources and changes experienced over time.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in a wireless communication device. The wireless communication device of some examples includes a processing system that includes one or more processors and one or more memories coupled with the one or more processors. The processing system of some examples is operable to cause the wireless communication device to receive, from a wireless communication device, a routing request message for one or more communication-aware routes associated with a radio map for roadway areas of a region associated with a plurality of network nodes. The processing system of some examples is operable to cause the wireless communication device to generate, in association with receiving the routing request message, the one or more communication-aware routes for a vehicle associated with the wireless communication device to travel a route of the one or more communication-aware routes. The processing system of some examples is also operable to transmit, in association with receiving the routing request message, reservation/priority information regarding communication resources of a network node of the plurality of network nodes. The network node may be associated with at least one roadway within the region corresponding to the route.

Another innovative aspect of the subject matter described in this disclosure can be implemented in a method for wireless communication. The method of some examples includes receiving, from a wireless communication device, a routing request message for one or more communication-aware routes associated with a radio map for roadway areas of a region associated with a plurality of network nodes. The method of some examples includes generating, in association with receiving the routing request message, the one or more communication-aware routes for a vehicle associated with the wireless communication device to travel a route of the one or more communication-aware routes. The method of some examples also includes transmitting, in association with receiving the routing request message, reservation/priority information regarding communication resources of a network node of the plurality of network nodes. The network node may be associated with at least one roadway within the region corresponding to the route.

In some examples of the methods and wireless communication devices, the reservation/priority information may include one or more bandwidth reservation messages to reserve respective communication resources of the network node for wireless communication as the vehicle travels the route. Additionally or alternatively, the reservation/priority information may include one or more communication resource priority messages to establish communication priority, for respective communication resources of the network node, to wireless communication associated with the vehicle as the vehicle travels the route.

Some examples of the methods and wireless communication devices may identify a portion of the roadway areas of the region associated with the plurality of network nodes traversed by the route having one or more undesirable communication attribute with respect to communication of high definition (HD) map information. Some examples of the methods and wireless communication devices may transmit HD map communication information associated with one or more roadway of the portion of roadway areas for transmission, the HD map communication information coordinating communication of one or more portions of HD map information, by a first network node of the plurality of network nodes associated with one or more roadway of the roadway areas traversed by the route prior to the portion of the roadway areas and having one or more desirable communication attribute with respect to communication of HD map information, to the wireless communication device as the vehicle travels the route.

Some examples of the methods and wireless communication devices may transmit, to the wireless communication device in association with receiving the routing request message, information regarding the one or more communication-aware routes. The information regarding the one or more communication-aware routes may include at least one of information regarding an average communication rate along the route, information regarding a road segment along the route having one or more undesirable communication attribute, information regarding one or more applications to be enabled along the route, or any combination thereof.

Another innovative aspect of the subject matter described in this disclosure can be implemented in a wireless communication device. The wireless communication device of some examples includes a processing system that includes one or more processors and one or more memories coupled with the one or more processors. The processing system of some examples is operable to cause the wireless communication device to transmit, to a routing system, a routing request message for one or more communication-aware routes associated with a radio map for roadway areas of a region associated with a plurality of network nodes. The routing request message may include information regarding application utilization associated with traveling a route of the one or more communication-aware routes. The processing system of some examples is operable to cause the wireless communication device to receive the one or more communication-aware routes for a vehicle to travel the route.

Another innovative aspect of the subject matter described in this disclosure can be implemented in a method for wireless communication. The method of some examples includes transmitting, to a routing system, a routing request message for one or more communication-aware routes associated with a radio map for roadway areas of a region associated with a plurality of network nodes. The routing request message may include information regarding application utilization associated with traveling a route of the one or more communication-aware routes. The method of some examples includes receiving the one or more communication-aware routes for a vehicle to travel the route.

In some examples of the methods and wireless communication devices, the information regarding application utilization may include at least one of information regarding one or more applications currently active or desired to become active in association with use by one or more passenger devices of the vehicle, one or more applications currently active or desired to become active in association with use by the vehicle, or any combination thereof. Additionally or alternatively, the information regarding application utilization may include one or more communication metrics, the one or more communication metrics including at least one of an application communication metric regarding one or more applications currently active or desired to become active during a time in which the vehicle travels the route, an uplink communication metric regarding an uplink to be provided in association with the vehicle when traveling the route, a downlink communication metric regarding a downlink to be provided in association with the vehicle when traveling the route, or any combination thereof.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (for example, end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (for example, hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a network node and a user equipment (UE) according to one or more aspects.

FIG. 3 is a block diagram of an example wireless communications system that supports communication-aware routing with application planning according to one or more aspects.

FIG. 4 is a diagram illustrating examples of routes generated with communication utilization information taken into consideration according to one or more aspects.

FIG. 5 is a ladder diagram illustrating example operations implemented for providing communication-aware routing with application planning according to one or more aspects.

FIGS. 6 and 7 are flow diagrams illustrating example processes that support communication-aware routing with application planning according to one or more aspects.

FIG. 8 is a block diagram of an example UE that supports communication-aware routing with application planning according to one or more aspects.

FIG. 9 is a block diagram of an example routing system that supports communication-aware routing with application planning according to one or more aspects.

FIG. 10 is a block diagram of an example network node that supports communication-aware routing with application planning according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support communication-aware routing with application planning. Communication-aware routing with application planning of some examples generates one or more routes for traveling between locations (for example, selected origination and destination points) with application planning by considering communication information and application utilization information with respect to traveling the route. The communication information may include information regarding communication resources, capabilities, availability, coverage, etc. (hereinafter referred to collectively as “network communication information”) of wireless network infrastructure located along a route, communication resources, capabilities constraints, needs, utilization, etc. (hereinafter referred to collectively as “communication utilization information”) of one or more device (for example, user equipment (UE)) of or associated with a vehicle to travel the route, or a combination thereof. The application utilization information may include information regarding one or more applications (for example, applications currently in use, expected to be used, which may be used, etc.) and their use associated with traveling a route.

A routing request message for communication-aware routing of some examples may include application utilization information, such as for use in application planning with respect to route determination associated with a vehicle traveling between locations. One or more communication-aware routes with application planning may be generated with consideration of communication needs associated with a vehicle traveling the routes, such based on the application utilization information associated with a vehicle traveling a route and the communication utilization information.

A routing response message including one or more communication-aware routes with application planning may be provided, such as to a device of or associated with a vehicle, for choosing in travel between origination and destination points. Various information, may be provided in or with the routing response message, such as for use in guiding selection of a particular communication-aware route satisfying an aspect or aspects of an application utilization experience while traveling the route. According to some examples, information regarding an expected experience (for example, information regarding communication quality, interruptions, etc.) with respect to application utilization associated with a vehicle traveling a route of the one or more communication routes may be provided in or with the routing response message.

According to some examples, communication resource reservation/priority may be implemented in association with communication-aware routing with application planning. For example, reservation/priority information regarding communication resources of a network node associated with at least one roadway of a communication-aware routing selection may be provided to the network node. Reservation/priority information may, for example, include one or more bandwidth reservation messages configured to reserve respective communication resources of the network node for wireless communication as the vehicle travels the route. According to some examples, the reserved resources may only be used with respect to the particular vehicle traveling the communication-aware route. Reservation/priority information may additionally or alternatively include one or more communication resource priority messages to establish communication priority, for respective communication resources of the network node, to wireless communication associated with the vehicle as the vehicle travels the route. In accordance with some examples, the corresponding level of priority to communicate in the uplink, downlink, or both may be provided with respect to the particular vehicle traveling the communication-aware route.

Particular implementations of the subject matter described in this disclosure may be implemented to realize one or more of the following potential advantages or benefits. In some aspects, the present disclosure provides techniques for routing vehicles for better communication when traveling between locations. For example, communication-aware routing having application planning according to aspects of the disclosure facilitates one or more desired aspects of wireless communication with respect to various applications, such as autonomous driving applications, tele-operated driving applications, relatively high bandwidth applications, etc., in association with traversal of the route. Communication-aware routing with application planning may accommodate applications having different communication utilization needs, such as to be more efficient for applications with elastic communication needs, to enable reliable communication for applications with stringent communication needs, or a combination thereof.

It can be seen from the above that this disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, 4^{th} Generation (4G) or Long Term Evolution (LTE) networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (for example, end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (for example, radio frequency (RF)-chain, communication interface, processor), distributed arrangements, end-user devices, etc. of varying sizes, shapes, and constitution.

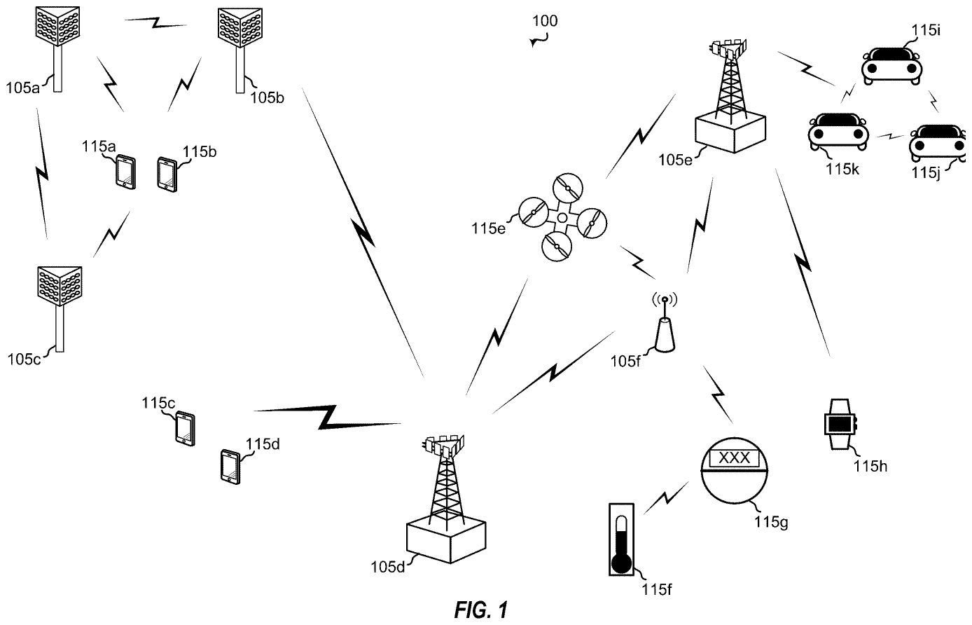

FIG. 1 is a block diagram illustrating details of an example wireless communication system according to one or more aspects. The wireless communication system may include wireless network 100. Wireless network 100 may, for example, include a 5G wireless network or alternatively a 4G/LTE network. As appreciated by those skilled in the art, components appearing in FIG. 1 are likely to have related counterparts in other network arrangements including, for example, cellular-style network arrangements and non-cellular-style-network arrangements (for example, device to device or peer to peer or ad hoc network arrangements, etc.).

Wireless network 100 illustrated in FIG. 1 includes a number of network nodes 105 and other network entities. A network node may be a station that communicates with the UEs and may also be referred to as an evolved node B (eNB), a next generation eNB (gNB), a base station, an access point, and the like. Each network node 105 may provide communication coverage for a particular geographic area. In documents provided from an organization named “3^{rd} Generation Partnership Project (3GPP), the term “cell” may refer to this particular geographic coverage area of a network node or a network node subsystem serving the coverage area, depending on the context in which the term is used. In implementations of wireless network 100 herein, network nodes 105 may be associated with a same operator or different operators (for example, wireless network 100 may include a plurality of operator wireless networks). Additionally, in implementations of wireless network 100 herein, network node 105 may provide wireless communications using one or more of the same frequencies (for example, one or more frequency bands in licensed spectrum, unlicensed spectrum, or a combination thereof) as a neighboring cell. In some examples, an individual network node 105 or UE 115 may be operated by more than one network operating entity. In some other examples, each network node 105 and UE 115 may be operated by a single network operating entity.

A network node may provide communication coverage for a macro cell or a small cell, such as a pico cell or a femto cell, or other types of cell. A macro cell generally covers a relatively large geographic area (for example, several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (for example, a home) and, in addition to unrestricted access, may also provide restricted access by UEs having an association with the femto cell (for example, UEs in a closed subscriber group (CSG), UEs for users in the home, and the like). A network node for a macro cell may be referred to as a macro network node. A network node for a small cell may be referred to as a small cell network node, a pico network node, a femto network node or a home network node. In the example shown in FIG. 1, network nodes 105d and 105e are regular macro network nodes, while network nodes 105a-105c are macro network nodes enabled with one of 3 dimension (3D), full dimension (FD), or massive multiple input, multiple output (MIMO). Network nodes 105a-105c take advantage of their higher dimension MIMO capabilities to exploit 3D beamforming in both elevation and azimuth beamforming to increase coverage and capacity. Network node 105f is a small cell network node which may be a home node or portable access point. A network node may support one or multiple (for example, two, three, four, and the like) cells.

Wireless network 100 may support synchronous or asynchronous operation. For synchronous operation, the network nodes may have similar frame timing, and transmissions from different network nodes may be approximately aligned in time. For asynchronous operation, the network nodes may have different frame timing, and transmissions from different network nodes may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), a vehicle-to-everything (V2X) module, an in-vehicle telemetrics device, mobile hotspot, vehicle infotainment system, advanced driver assistance system (ADAS), a navigation system, a media player, a virtual assistant device, etc. A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array; industrial automation and enterprise devices; consumer and wearable devices, such as eyewear, a wearable camera, a smart watch, a health or fitness tracker, a mammal implantable device, gesture tracking device, medical device, a digital audio player (for example, MP3 player), a camera, a game console, etc. ; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the network nodes, whether macro network nodes, pico network nodes, femto network nodes, relays, and the like. In FIG. 1, a communication link (represented as a lightning bolt) indicates wireless transmissions between a UE and a serving network node, which is a network node designated to serve the UE on the downlink or uplink, or desired transmission between network nodes, and backhaul transmissions between network nodes. UEs may operate as network nodes (for example, base stations) in some scenarios. Backhaul communication between network nodes of wireless network 100 may occur using wired or wireless communication links.

In operation at wireless network 100, network nodes 105a-105c serve UEs 115a and 115b using 3D beamforming and coordinated spatial techniques, such as coordinated multipoint (CoMP) or multi-connectivity. Macro network node 105d performs backhaul communications with network nodes 105a-105c, as well as small cell, network node 105f. Macro network node 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro network nodes 105d and 105e, as well as small cell network node 105f. Other machine type devices, such as UE 115f (thermometer), UE 115g (smart meter), and UE 115h (wearable device) may communicate through wireless network 100 either directly with network nodes, such as small cell network node 105f, and macro network node 105e, or in multi-hop configurations by communicating with another user device which relays its information to the network, such as UE 115f communicating temperature measurement information to the smart meter, UE 115g, which is then reported to the network through small cell network node 105f. Wireless network 100 may also provide additional network efficiency through dynamic, low-latency time division duplex (TDD) communications or low-latency frequency division duplex (FDD) communications, such as in a vehicle-to-vehicle (V2V) mesh network between UEs 115i-115k communicating with macro network node 105e.

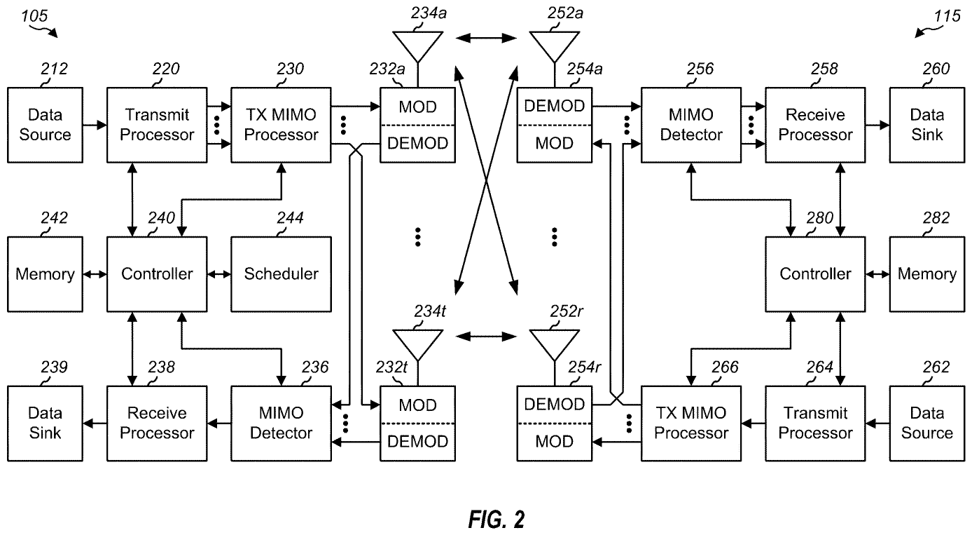

FIG. 2 is a block diagram illustrating examples of network node 105 and UE 115 according to one or more aspects. Network node 105 and UE 115 may be any of the network nodes and one of the UEs in FIG. 1. For a restricted association scenario (as mentioned above), network node 105 may be small cell network node 105f in FIG. 1, and UE 115 may be UE 115c or 115d operating in a service area of network node 105f, which in order to access small cell network node 105f, would be included in a list of accessible UEs for small cell network node 105f. Network node 105 may also be a network node of some other type. As shown in FIG. 2, network node 105 may be equipped with antennas 234a through 234t, and UE 115 may be equipped with antennas 252a through 252r for facilitating wireless communications.

At network node 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (for example, encode and symbol map) the data and control information to obtain data symbols and control symbols, respectively. Transmit processor 220 may also generate reference symbols, for example, for the primary synchronization signal (PSS) and secondary synchronization signal (SSS), and cell-specific reference signal. Transmit (TX) MIMO processor 230 may perform spatial processing (for example, precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (for example, for OFDM, etc.) to obtain an output sample stream. Each modulator 232 may additionally or alternatively process (for example, convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from network node 105 and may provide received signals to demodulators (DEMODs) 254a through 254r, respectively. Each demodulator 254 may condition (for example, filter, amplify, downconvert, and digitize) a respective received signal to obtain input samples. Each demodulator 254 may further process the input samples (for example, for OFDM, etc.) to obtain received symbols. MIMO detector 256 may obtain received symbols from demodulators 254a through 254r, perform MIMO detection on the received symbols if applicable, and provide detected symbols. Receive processor 258 may process (for example, demodulate, deinterleave, and decode) the detected symbols, provide decoded data for UE 115 to data sink 260, and provide decoded control information to controller 280, such as a processor.

On the uplink, at UE 115, transmit processor 264 may receive and process data (for example, for a physical uplink shared channel (PUSCH)) from data source 262 and control information (for example, for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (for example, for SC-FDM, etc.), and transmitted to network node 105. At network node 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

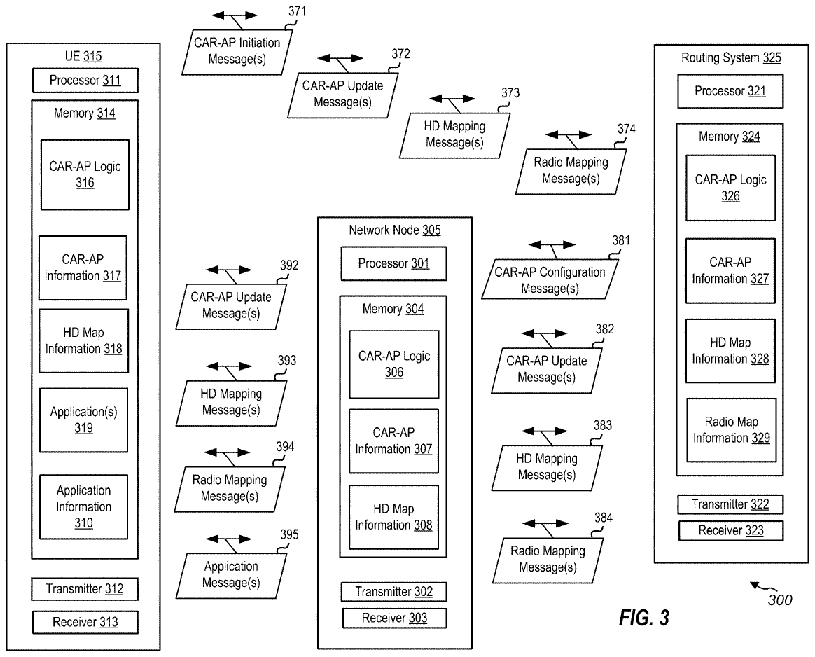

Controllers 240 and 280 may direct the operation at network node 105 and UE 115, respectively. Controller 240 or other processors and modules at network node 105 or controller 280 or other processors and modules at UE 115 may perform or direct the execution of various processes for the techniques described herein, such as to perform or direct the execution illustrated in FIGS. 3, 5, 6, and 7, or other processes for the techniques described herein. Memories 242 and 282 may store data and program codes for network node 105 and UE 115, respectively. Scheduler 244 may schedule UEs for data transmission on the downlink or the uplink.

Infrastructure providing services of or in association with a wireless network, such as wireless network 100, is typically distributed non-uniformly within any particular service area. Communication resources of wireless network infrastructure, for example, are generally distributed geographically non-uniformly, and change with time. As an example, some areas may have denser network node deployments while other areas may have less dense network node deployments. Similarly, edge computation facilities and resources, as may be used by machine learning based algorithms and applications such as virtual reality (VR) and augmented reality (AR), are distributed geographically non-uniformly.

Wireless communication rate varies with blockage and environment and is likewise dependent on the location. Radio maps may be generated to keep track of edge computation and radio performance information for various areas served by a wireless network. Radio maps are generally useful in providing information regarding communication services coverage and availability with respect to locations within the service area of a wireless network, and thus may be utilized in communication-aware routing of vehicles through the wireless network service area. Communication-aware routing in general provides routing of vehicles in relation to communication infrastructure located along a route. For example, a route determined according to a communication-aware routing technique may be selected so as to maintain all or much of the route within communication proximity to communication infrastructure, such as network nodes, access points, and other network nodes providing wireless communication. Communication-aware routing utilizing a radio map as described above, although potentially providing a route configured to keep a vehicle within communication service coverage, may nevertheless fail to satisfactorily support or otherwise accommodate application utilization associated with the vehicle traveling the route.

Vehicle traffic within service areas of a wireless network is typically geographically non-uniform, and changes with time. The wireless communication needs for or associated with any particular vehicle may be elastic or stringent. For example, applications such as web surfing, VR, and AR, may provide for bursty, often resilient data communications which, although possibly relatively high bandwidth, allow for elasticity with respect to aspects of their communication needs (for example, communication quality, communication rate, etc.). Applications such as video streaming and gaming, however, may have more stringent communication needs (for example, communication quality, communication rate, etc. supporting a minimum level of communication services to avoid latency or dropping). Applications related to autonomous driving and tele-operated driving generally have stringent and seamless communication needs (for example, communication quality, communication rate, etc. supporting uninterrupted, reliable, and low-latency transmission of messages for high definition (HD) maps, traffic condition, road information, accidents, emergency vehicles, etc.). Wireless communication performance or user experience associated with wireless communication may be degraded significantly along routes with lesser or limited services.

According to aspects of the disclosure, vehicles are routed for communication from a source to a destination meeting one or more desired aspects (for example, uninterrupted communication, communication providing desired user experience, communication maintaining satisfactory or acceptable quality, etc.). Communication-aware routing according to some examples of the present disclosure is provided with application planning for generating one or more routes for traveling between locations considering various communication utilization information (for example, communication resources, capabilities constraints, needs, utilization, etc.) and application utilization information (for example, information regarding one or more applications and their use) associated with a vehicle traveling a route. For example, communication-aware routing having application planning according to aspects of the disclosure not only provides routing of vehicles in relation to network communication information (for example, communication resources, capabilities, availability, coverage, etc.) of communication infrastructure located along a route, but also facilitates one or more desired aspects of wireless communication with respect to various applications through consideration of application utilization information and communication utilization information associated with the vehicle. Communication-aware routing with application planning of some examples may, for example, provide routing of vehicles to be more efficient for applications with elastic communication needs, to enable applications with stringent communication needs, or a combination thereof.

FIG. 3 is a block diagram of an example wireless communications system 300 that supports communication-aware routing with application planning according to one or more aspects. In some examples, wireless communications system 300 may implement aspects of wireless network 100. Wireless communications system 300 is illustrated as including UE 315, network node 305, and routing system 325. Although one UE 315, one network node 305, and one routing system 325 are illustrated, in some other implementations, wireless communications system 300 may generally include multiple UEs 315, multiple network nodes 305, and more than one routing system 325. In some implementations, wireless communications system 300 implements a 5G NR network. For example, wireless communications system 300 may include multiple 5G-capable UEs 315 and multiple 5G-capable network nodes 305, such as UEs and network nodes configured to operate in accordance with a 5G NR network protocol such as that defined by the 3GPP.

UE 315 of the example illustrated in FIG. 3 may comprise a vehicle, such as a vehicle corresponding to any of UEs 115i, 115j, and 115k of FIG. 1, implementing one or more applications utilizing wireless communications (for example, autonomous driving or tele-operated driving applications). Additionally or alternatively, UE 315 may comprise a device associated with a vehicle (for example, carried or utilized by a passenger of the vehicle), such as a device of UEs 115a, 115b, 115c, 115d, 115e, 115f, 115g, and 115h of FIG. 1, implementing one or more applications utilizing wireless communications (for example, web browser, video streaming, VR, AR, or gaming). That is, according to some examples, a vehicle may itself comprise one or more devices each executing one or more applications for which communication-aware routing with application planning is to be provided, a vehicle may have one or more devices (for example, user devices) associated therewith and each executing one or more applications for which communication-aware routing with application planning is to be provided, or a combination thereof.

UE 315 may include a variety of components (such as structural, hardware components) used for carrying out one or more functions described herein. For example, these components may include one or more processors 311 (hereinafter referred to collectively as “processor 311”), one or more transmitters 312 (hereinafter referred to collectively as “transmitter 312”), one or more receivers 313 (hereinafter referred to collectively as “receiver 313”), and one or more memory devices 314 (hereinafter referred to collectively as “memory 314”).

Processor 311 may be configured to execute instructions stored in memory 314 to perform the operations described herein. In some implementations, processor 311 includes or corresponds to one or more of receive processor 258, transmit processor 264, and controller 280, and memory 314 includes or corresponds to memory 282. A processing system of UE 315 may, for example, include processor 311 coupled with memory 314 and be configured to cause UE 315 to perform one or more functions described herein.

Memory 314 includes or is configured to store various instruction sets, algorithms, software, logic, etc. (hereinafter referred to collectively as “logic”) for operation of UE 315, and various data, parameters, statistics, information, etc. (hereinafter referred to collectively as “information”) used in association with operation of UE 315. The illustrated example of memory 314 includes communication-aware routing with application planning (CAR-AP) logic 316, CAR-AP information 317, HD map information 318, one or more application(s) 319, and application information 310.

CAR-AP logic 316 of the example is configured for implementation of communication-aware routing with application planning by UE 315, utilizing information of CAR-AP information 317 and HD map information 318, as described in further detail below. Communication-aware routing with application planning provided in association with CAR-AP logic 316 may, for example, facilitate supporting or otherwise accommodating utilization of application(s) 319 associated with the vehicle traveling the route, as described in further detail below.

CAR-AP logic 316 of some examples may include logic for requesting or otherwise initiating communication-aware routing with application planning, for selecting and implementing a route providing communication-aware routing with application planning, for facilitating traversal of a route providing communication-aware routing with application planning, for facilitating utilization of one or more applications in association with traversal of a route, for providing information for updating one or more aspects of a route determined for providing communication-aware routing with application planning, for implementing one or more updates to a route providing communication-aware routing with application planning, for providing information for managing and updating HD map information, etc. CAR-AP information 317 of some examples may include preferences (for example, routing preferences, communication preferences, etc.), travel needs, travel constraints, travel capabilities, application utilization information (for example, number of passengers/devices in or associated with a vehicle to travel a route providing communication-aware routing with application planning, applications being active or expected to be active in association with the vehicle traveling the route, quality of service (QoS) needs with respect to the applications, etc.), and the like. CAR-AP information 317 of some examples may additionally or alternatively include communication utilization information (for example, information regarding communication use, communication needs, communication constraints, communication capabilities, communication resources, etc.), origination and destination points, one or more communication-aware routes obtained or otherwise determined with respect to the origination and destination points, etc. Information regarding communication constraints, communication capabilities, communication resources, etc. may be determinable from information identifying a model or type of device (for example, vehicle type/model, wireless communication device type/model, etc.). CAR-AP information 317 of some examples may include information identifying a model or type of device.

HD map information 318 of some examples may include HD map data of a HD map (for example, highly detailed, highly accurate maps that represent location data including various features, such as lane markings, road edges, signage, etc.) for one or more roadways within an area which a vehicle associated with UE 315 is or may travel. UE 315 of some examples may store HD map information for roadways of an area or areas associated with a route the vehicle is presently traveling or currently expected to travel. Additionally or alternatively, UE 315 may store HD map information for roadways of one or more areas (for example, an area of a home town, an area of a home state, areas commonly traveled by the vehicle, areas selected by a user, etc.) for which the vehicle is not presently traveling or currently expected to travel. Information provided by HD map information 318 may be utilized by CAR-AP logic 316, application(s) 319, or any combination thereof in combination with CAR-AP information 317 to facilitate utilization of one or more applications in accordance with one or more aspects of the application utilization information, the communication utilization information, or any combination thereof in association with traversal of a route.

Application(s) 319 comprise one or more applications executable by one or more processors 311 to provide functionality of UE 315. Application(s) 319 may, for example, include one or more applications implementing autonomous driving, tele-operated driving, etc. Additionally or alternatively, application(s) 319 may include one or more applications for web browsing, video streaming, VR, AR, gaming etc. Application information 310 may comprise information (for example, application data, application settings, user preference information, etc.) utilized by or in association with one or more applications of application(s) 319.

CAR-AP information 317, HD map information 318, and application information 310 are shown separately in the example illustrated in FIG. 3. In accordance with some examples, any or all of CAR-AP information 317, HD map information 318, and application information 310, or portions thereof, may be provided in a combined implementation at UE 315 according to aspects of the disclosure. For example, HD map information may be provided with aspects of CAR-AP information in correspondence with particular roadways of the HD map to be or being traversed by the vehicle. In another example, HD map information may be provided as application information 310 in association with an autonomous driving or tele-operated driving application of application(s) 319. In a further example, CAR-AP information may be provided as application information 310 in association with a map application of application(s) 319.

Transmitter 312 is configured to transmit reference signals, control information, and data to one or more other devices, and receiver 313 is configured to receive references signals, synchronization signals, control information, and data from one or more other devices. For example, transmitter 312 may transmit signaling, control information, and data (for example, one or more messages of CAR-AP initiation message(s) 371, HD mapping message(s) 373, radio mapping message(s) 374, etc.) to, and receiver 313 may receive signaling, control information, and data (for example, one or more messages of CAR-AP initiation message(s) 371, HD mapping message(s) 373, radio mapping message(s) 374, etc.) from, routing system 325, such as directly or via one or more network nodes (for example, network node 305 or one or more other network nodes, not shown). Additionally or alternatively, transmitter 312 may transmit signaling, control information, and data (for example, one or messages of CAR-AP update message(s) 392, HD mapping message(s) 393, radio mapping message(s) 394, application message(s) 395, etc.) to, and receiver 313 may receive signaling, control information, and data (for example, one or messages of CAR-AP update message(s) 392, HD mapping message(s) 393, radio mapping message(s) 394, application message(s) 395, etc.) from, network node 305. In some implementations, transmitter 312 and receiver 313 may be integrated in one or more transceivers. Additionally or alternatively, transmitter 312 or receiver 313 may include or correspond to one or more components of UE 115 described with reference to FIG. 2.

Network node 305 of the example illustrated in FIG. 3 may comprise a network node, access point, or other network element that communicates with UEs of wireless communication system 300. Network node 305 may, for example, comprise a network node corresponding to any of network nodes 105a, 105b, 105c, 105d, 105e and 105f of FIG. 1. Network node 305 may be arranged in multiple manners with various components or constituent parts. For example, network node 305 may be implemented as an aggregated network node (for example, a standalone network node or a monolithic network node) or a disaggregated network node. An aggregated network node implementation may be configured to utilize a radio protocol stack that is physically or logically integrated within a single radio access network (RAN) node. A disaggregated network node implementation may be configured to utilize a protocol stack that is physically or logically distributed among two or more units (such as one or more central or centralized units (CUs), one or more distributed units (DUs), or one or more radio units (RUS)).

Network node 305 may include a variety of components (such as structural, hardware components) used for carrying out one or more functions described herein. For example, these components may include one or more processors 301 (hereinafter referred to collectively as “processor 301”), one or more transmitters 302 (hereinafter referred to collectively as “transmitter 302”), one or more receivers 303 (hereinafter referred to collectively as “receiver 303”), and one or more memory devices 304 (hereinafter referred to collectively as “memory 304”).

Processor 301 may be configured to execute instructions stored in memory 304 to perform the operations described herein. In some implementations, processor 301 includes or corresponds to one or more of receive processor 238, transmit processor 220, and controller 240, and memory 304 includes or corresponds to memory 242. A processing system of Network node 305 may, for example, include processor 301 coupled with memory 304 and be configured to cause network node 305 to perform one or more functions described herein.

Memory 304 includes or is configured to store logic for operation of network node 305, and information used in association with operation of network node 305. The illustrated example of memory 304 incudes CAR-AP logic 306, CAR-AP information 307, and HD map information 308.

CAR-AP logic 306 of the example is configured for implementation of communication-aware routing with application planning by network node 305, utilizing information of CAR-AP information 307 and HD map information 308, as described in further detail below. Communication-aware routing with application planning provided in association with CAR-AP logic 306 may, for example, facilitate supporting or otherwise accommodating utilization of applications with a vehicle traveling a route served by network node 305, as described in further detail below.

CAR-AP logic 306 of some examples may include logic for configuring communication resources (for example, reserving resources, establishing communication priorities, etc.) of network node 305 for supporting communication-aware routing with application planning with respect to a vehicle traversing one or more roadway for which communication services are provided by network node 305, for obtaining information (for example, HD map information, CAR-AP information, etc.) from routing system 325 for supporting communication-aware routing with application planning, for providing information (for example, HD map information, CAR-AP information, application information, etc.) to one or more UEs of or associated with the vehicle for supporting communication-aware routing with application planning, for obtaining information (for example, HD map information, CAR-AP information, application information, etc.) from one or more UE of or associated with the vehicle for supporting communication-aware routing with application planning, for providing information (for example, HD map information, CAR-AP information, etc.) to routing system 325 for supporting communication-aware routing with application planning, etc. CAR-AP information 307 of some examples may include CAR-AP information of UE 315, of routing system 325, or a combination thereof (for example, CAR-AP information relayed between UE 315 and routing system 325), information regarding a vehicle traveling or to travel one or more roadway for which communication services are provided by network node 305, information regarding a route being traveled or to be traveled by the vehicle, information regarding applications being active or expected to be active in association with the vehicle traveling the route, QoS needs with respect to the applications, communication resource configuration information (for example, resource reservation information, communication priority information, etc.) for supporting communication-aware routing with application planning with respect to the vehicle, etc. CAR-AP information 307 of some examples may additionally or alternatively include update information regarding a change in or to one or more aspects of the application utilization information, the communication utilization information, or other information relevant to supporting communication-aware routing with application planning.

HD map information 308 of some examples includes HD map data for one or more roadways within an area for which communication services are provided by wireless communications system 300. Network node 305 of some examples may store HD map information for roadways of an area for which communication services are provided to by network node 305. Additionally or alternatively, network node 305 may store HD map information for roadways of one or more areas for which communication services are not directly provided by network node 305, such as areas for which communication services are provided by network nodes neighboring network node 305 in wireless communications system 300.

CAR-AP information 307 and HD map information 308 are shown separately in the example illustrated in FIG. 3. In accordance with some examples, CAR-AP information 307 and HD map information 308, or portions thereof, may be provided in a combined implementation at network node 305 according to aspects of the disclosure. For example, HD map information may be provided with aspects of CAR-AP information in correspondence with particular roadways of the HD map to be or being traversed by the vehicle.

Transmitter 302 is configured to transmit reference signals, synchronization signals, control information, and data to one or more other devices, and receiver 303 is configured to receive reference signals, control information, and data from one or more other devices. For example, transmitter 302 may transmit signaling, control information, and data (for example, CAR-AP configuration message(s) 381, CAR-AP update message(s) 382, HD mapping message(s) 383, radio mapping message(s) 384 etc.) to, and receiver 303 may receive signaling, control information, and data (for example, CAR-AP configuration message(s) 381, CAR-AP update message(s) 382, HD mapping message(s) 383, radio mapping message(s) 384, etc.) from, routing system 325, such as via one or more wireless or wireline links. Additionally or alternatively, transmitter 302 may transmit signaling, control information, and data (for example, CAR-AP update message(s) 392, HD mapping message(s) 393, radio mapping message(s) 394, application message(s) 395, etc.) to, and receiver 303 may receive signaling, control information, and data (for example, CAR-AP update message(s) 392, HD mapping message(s) 393, radio mapping message(s) 394, application message(s) 395, etc.) from, UE 315. In some implementations, transmitter 302 and receiver 303 may be integrated in one or more transceivers. Additionally or alternatively, transmitter 302 or receiver 303 may include or correspond to one or more components of network node 105 described with reference to FIG. 2.

Routing system 325 of the example illustrated in FIG. 3 may comprise one or processor-based systems configured to provide analysis of roadway systems for determining routes between locations. Some examples of routing system 325 may comprise one or more systems of an Internet routing application company, an automobile manufacturing company, a telecommunication company, etc. Routing system 325 of some examples may include one or more routing service servers (RSSs), radio mapping servers, HD mapping servers, storage servers, etc. configured for determining routes between locations in accordance with communication-aware routing with application planning of aspects of the present disclosure. According to aspects of the disclosure, routing system 325 may be provided in a cloud implementation, wherein functionality thereof is distributed among various systems of or connected to wireless communications system 300. Some examples of routing system 325 may comprise an edge implementation, wherein one or more devices or systems (for example, servers) of routing system 325 are in communication with wireless communications system 300 as an edge device. Additionally or alternatively, some examples of routing system 325 may comprise an integrated implementation, wherein functionality of the routing system is provided by one or more network devices or systems (for example, network node 305).

Routing system 325 may include a variety of components (such as structural, hardware components) used for carrying out one or more functions described herein. For example, these components may include one or more processors 321 (hereinafter referred to collectively as “processor 321”), one or more transmitters 322 (hereinafter referred to collectively as “transmitter 322”), one or more receivers 323 (hereinafter referred to collectively as “receiver 323”), and one or more memory devices 324 (hereinafter referred to collectively as “memory 324”).

Processor 321 may be configured to execute instructions stored in memory 324 to perform the operations described herein. In some implementations, processor 321 includes or corresponds to one or more receive processors, transmit processors, and controllers. A processing system of routing system 325 may, for example, include processor 321 coupled with memory 324 and be configured to cause routing system 325 to perform one or more functions described herein.

Memory 324 includes or is configured to store logic for operation of routing system 325, and information used in association with operation of routing system 325. The illustrated example of memory 324 includes CAR-AP logic 326, CAR-AP information 327, HD map information 328, and radio map information 329.

CAR-AP logic 326 of the example is configured for generation and implementation of communication-aware routing with application planning by routing system 325, utilizing information of CAR-AP information 327, HD map information 328, and radio map information 329, as described in further detail below. Communication-aware routing with application planning provided in association with CAR-AP logic 326 may, for example, determine and generate one or more communication-aware routes for supporting or otherwise accommodating utilization of applications with a vehicle traveling a route of the one or more communication-aware routes, as described in further detail below.

CAR-AP logic 326 of some examples may include logic for determining one or more routes for communication-aware routing with application planning (for example, in response to a request by UE 315), for initiating communication-aware routing with application planning (for example, in response to selection of a route by UE 315), for providing information (for example, HD map information, CAR-AP information, etc.) to one or more UEs of or associated with a vehicle traversing or to traverse a route supporting communication-aware routing with application planning, for providing communication resource configuration information (for example, reserving resources, establishing communication priorities, etc.) to network node 305 for supporting communication-aware routing with application planning, for providing information (for example, HD map information, CAR-AP information, etc.) to one or more network nodes providing communication services with respect to areas associated with the vehicle, for obtaining information (for example, HID map information, CAR-AP information, etc.) from one or more UE of or associated with the vehicle for supporting communication-aware routing with application planning, for obtaining information (for example, HD map information, CAR-AP information, etc.) from one or more network nodes providing communication services with respect to areas associated with the vehicle, for updating one or more aspects of a route determined for providing communication-aware routing with application planning (for example, in association with receiving updated information from UE 315, network node 305, etc.), for updating HD map information (for example, in association with receiving updated information from UE 315, network node 305, etc.), etc. CAR-AP information 327 of some examples may include CAR-AP information of UE 315, of network node 305, or a combination thereof, information regarding a vehicle traveling or to travel one or more roadway for which communication services are provided or to be provided by wireless communications system 300, information regarding applications being active or expected to be active in association with the vehicle traveling the route, QoS needs with respect to the applications, communication resource configuration information for supporting communication-aware routing with application planning with respect to the vehicle, information and rules for determining one or more routes supporting communication-aware routes determined with respect to origination and destination points associated with a vehicle to be provided communication-aware routing with application planning, the one or more routes determined for supporting communication-aware routing with application planning, etc. CAR-AP information 327 of some examples may additionally or alternatively include update information regarding a change in or to one or more aspects of the application utilization information, the communication utilization information, or other information relevant to supporting communication-aware routing with application planning.

HID map information 328 of some examples includes HD map data for one or more roadways within areas for which communication services are provided by wireless communications system 300. Routing system 325 of some examples may store HD map information for roadways of an area for which communication-aware routing with application planning is or is to be provided by routing system 325. Additionally or alternatively, routing system 325 may store HD map information for roadways of one or more areas for which communication services are provided by network nodes of wireless communications system 300, such as to provide HD map information thereto.

Radio map information 329 of some examples includes radio environment information with respect to areas for which communication services are provided by wireless communications system 300. Routing system 325 of some examples may store radio map information for network nodes associated therewith (for example, network nodes in communication with routing system 325, network nodes for which routing system 325 provides communication-aware routing operation with respect to, etc.). According to some aspects, routing system 325 may store radio map information for all or some portion of the network nodes of wireless communication system 300 with which routing system 325 operates.

CAR-AP information 327, HD map information 328, and radio map information 329 are shown separately in the example illustrated in FIG. 3. In accordance with some examples, any or all of CAR-AP information 327, HD map information 328, and radio map information 329, or portions thereof, may be provided in a combined implementation at routing system 325 according to aspects of the disclosure. For example, HD map information may be provided with aspects of CAR-AP information in correspondence with particular roadways of the HD map to be or being traversed by the vehicle. In another example, HD map information may be provided in combination with radio map information 329 for providing radio environment information overlaid on high definition roadways data.

Transmitter 322 is configured to transmit reference signals, synchronization signals, control information, and data to one or more other devices, and receiver 323 is configured to receive reference signals, control information, and data from one or more other devices. For example, transmitter 322 may transmit signaling, control information, and data (for example, CAR-AP initiation message(s) 371, HD mapping message(s) 373, radio mapping message(s) 374, etc.) to, and receiver 323 may receive signaling, control information, and data (for example, CAR-AP initiation message(s) 371, HD mapping message(s) 373, radio mapping message(s) 374, etc.) from, UE 315. Additionally or alternatively, transmitter 322 may transmit signaling, control information, and data (for example, CAR-AP configuration message(s) 381, CAR-AP update message(s) 382, HD mapping message(s) 383, radio mapping message(s) 384, etc.) to, and receiver 323 may receive signaling, control information, and data (for example, CAR-AP configuration message(s) 381, CAR-AP update message(s) 382, HD mapping message(s) 383, radio mapping message(s) 384, etc.) from, network node 305. In some implementations, transmitter 322 and receiver 323 may be integrated in one or more transceivers.

According to some aspects, HD map information of HD map information 308, HD map information 318, and HD map information 328 may provide data regarding roadway infrastructure and topology, lane boundaries, road signals, crosswalks, traffic lights, etc. for use in vehicle navigation, such as by autonomous driving or tele-operated driving applications. HD map information may, for example, be collected by sensor equipped vehicles deployed to travel roadways and provide desired roadway environment information for HD map generation. Additionally or alternatively, HD map information, or some portion thereof, may be crowdsourced for HD map generation of large areas to include the requisite roadway data.

In an example of crowdsourced generation of HD map information, features in the roadway environments may be acquired by multiple intelligent vehicles and feature layers conveyed (for example, as messages of HD mapping message(s) 373) to a map cloud (for example, a map cloud of a cloud-based mapping system, such as may include routing system 325) through wireless communications system 300. The crowdsourced feature layers may be utilized to generate feature layers of the map cloud (for example, by operation of HD mapping logic, such as may be included in CAR-AP logic 326 or other logic (not shown) of the cloud-based mapping system).

According to some examples, HD map information may additionally or alternatively be updated or maintained using similar crowdsourcing techniques. For example, HD map information of HD map information 308, HD map information 318, and HD map information 328 may include update information (for example, acquired by an intelligent vehicle of or associated with UE 315) regarding a change in or to one or more aspects of roadway infrastructure and topology, lane boundaries, road signals, crosswalks, traffic lights, etc. relevant to updating an HD map or otherwise relevant to supporting communication-aware routing with application planning. The new features in the roadway environments may be conveyed (for example, as messages of HD mapping message(s) 393 and HD mapping message(s) 383) to the map cloud as new feature layers, such as while the vehicle operates within an area served by wireless communications system 300. The crowdsourced new feature layers may be integrated into a new feature layer in the map cloud (for example, by operation of HD mapping logic, such as may be included in CAR-AP logic 326 or other logic (not shown) of the cloud-based mapping system).

According to some aspects, radio map information of radio map information of radio map information 329 may provide information regarding location-specific edge computation and radio performance throughout one or more geographic areas. Wireless communication performance or user experience may be degraded significantly along routes with lesser or limited services. Radio quality information may be made available at the routing system in the form of radio map information 329 of some examples. Radio map information 329 may, for example, include geographic information data, radio device parameters, radio device state information, radio propagation models, and spectrum data, configured to provide accurate radio environment information corresponding to roadway locations within a geographic area of the radio map. Radio map information may, for example, be collected or otherwise obtained (for example, as messages of radio mapping message(s) 384) from various network nodes (for example, network node 305) in communication with routing system 325, for which routing system 325 provides communication-aware routing operation with respect to, of wireless communications system 300, etc. provide desired radio environment information for radio map generation, updating, and maintenance.

Information utilized with respect to communication-aware routing with application planning according to some aspects of the disclosure may be segmented or otherwise be designated as corresponding to segments of roadways associated with the respective information. For example, roadways within areas for which communication-aware routing with application planning is supported may be segmented along their lengths (for example, road segments in the range of 1 m to 100 m). According to some examples, each portion of a roadway may be segmented into one or more selected segment lengths. A roadway of some examples may not only be segmented along its length, but the segmentation of a portion of a roadway may include segmentation of its width (for example, to provide different, individual segments for each driving lane of a segmented roadway portion). Information with respect to a particular road segment may be identified by a road segment identifier (ID). Roadways of HD map information 308, HD map information 318, and HD map information 328 of some examples may be segmented such that roadway environment information of the HD map information is associated with a respective road segment, such as identified by road segment ID. Additionally or alternatively, roadways corresponding to radio map information 329 of some examples may be segmented such that radio environment information of the radio map information is associated with a respective road segment, such as identified by road segment ID. According to aspects of the disclosure, information (for example, HD map information, radio map information, etc.) is provided with a one-to-one correspondence with road segments of examples herein.

During operation of wireless communications system 300, one or more routes are determined with communication utilization information taken into consideration to provide communication-aware routing with application planning. A particular route having one or more desired attributes (for example, satisfying one or more aspects of communication utilization information, providing a satisfactory balance between communication coverage and travel time, providing uninterrupted, reliable, and low-latency communication, etc.) may be selected for traversal by a vehicle for which communication-aware routing with application planning is provided.

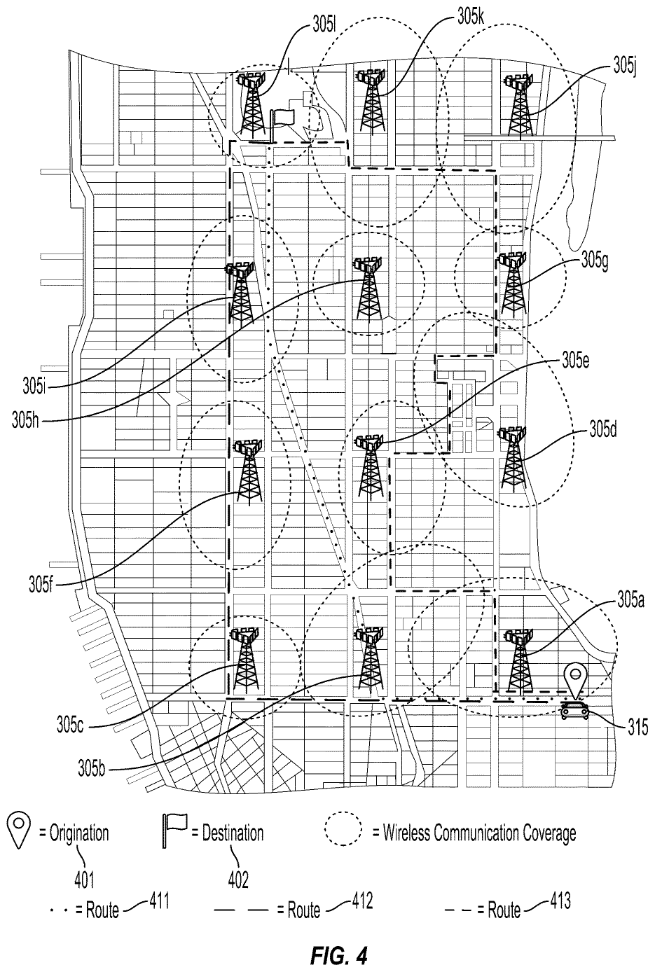

FIG. 4 is a diagram illustrating examples of routes generated with communication utilization information taken into consideration according to one or more aspects. In the example of FIG. 4, network nodes 305a, 305b, 305c, 305d, 305e, 305f, 305g, 305h, 305i, 305j, 305k, and 3051 (for example, each of which may correspond to an instance of network node 305 of FIG. 3) are located within an area served by wireless communications system 300 in which communication-aware routing with application planning is supported. Each dotted circle around a respective one of network nodes 305a, 305b, 305c, 305d, 305e, 305f, 305g, 305h, 305i, 305j, 305k, and 3051 indicates the area where wireless communication in accordance with the communication utilization information associated with UEs (for example, each of which may correspond to an instance of UE 315 of FIG. 3) of or associated with a particular vehicle is adequately supported (for example, aspects of the communication utilization information are satisfied). It should be appreciated that, although the dotted circles illustrated around network nodes 305a, 305b, 305c, 305d, 305e, 305f, 305g, 305h, 305i, 305j, 305k, and 3051 are shown as regular shapes for simplicity, the areas where wireless communication is supported by any or all the network nodes may be substantially irregular (for example, irregularities associated with shadowing, blockage, etc.) in many situations. Depending on how stringent communication needs associated with the vehicle are and the particular coverage areas served by the network nodes, one or more different routes may be provided according to examples.

In operation according to some examples, routing system 325, one or more (for example, each) of network nodes 305, or a combination thereof may determine the area where wireless communication in accordance with the communication utilization information associated with UEs of or associated with a particular vehicle is adequately supported. For example, CAR-AP logic 326 of routing system 325 may analyze various aspects of the information from CAR-AP initiation message(s) 371, CAR-AP information 327, HD map information 328, radio map information 329, or a combination thereof to determine the area where wireless communication in accordance with the communication utilization information associated with UEs of or associated with a particular vehicle is adequately supported by individual network nodes of network nodes 305a, 305b, 305c, 305d, 305e, 305f, 305g, 305h, 305i, 305j, 305k, and 3051. Additionally or alternatively, CAR-AP logic 306 of network node 305 may analyze various aspects of the information from CAR-AP configuration message(s) 381 (for example, as may include information from CAR-AP initiation message(s) 371), CAR-AP information 307, HD map information 308, and radio map information for network node 305, or a combination thereof to determine the area where wireless communication in accordance with the communication utilization information associated with UEs of or associated with a particular vehicle is adequately supported by network node 305. Network node 305 of some examples may provide information regarding where wireless communication in accordance with the communication utilization information associated with UEs of or associated with a particular vehicle is adequately supported by network node 305 to routing system 325, such as in CAR-AP configuration message(s) 381.

In accordance with some examples, routing system 325 may generate or otherwise determine one or more routes for traveling between selected origination and destination points with application planning by considering communication information (for example, information regarding the areas where wireless communication in accordance with the communication utilization information associated with UEs of or associated with a particular vehicle is adequately supported) and application utilization information. For example, CAR-AP logic 326 of routing system 325 may analyze various aspects of the information from CAR-AP configuration message(s) 381 (for example, as may include application utilization information), CARP-AP information 327, HID map information 328, radio map information 329, or a combination thereof to generate candidate routes (for example, routes 411, 412, 413, etc.) for traveling between the selected origination and destination points. The candidate routes may differ in various ways, such as the length or time of travel, the complexity of navigation, the reliability, quality, continuity, availability, etc. of communication services along the respective route.

Route 411 of FIG. 4 provides an example of a route associated with less stringent communication needs with respect to communication-aware routing with application planning. The example of route 411 includes appreciable gaps in which wireless communication in accordance with the communication utilization information associated with UEs of or associated with the vehicle is not adequately supported, although providing a relatively direct route between origination 401 and destination 402. Route 411 may, for example, be well suited for applications with elastic communication needs (for example, applications such as web surfing).

Route 412 of FIG. 4 provides an example of a route associated with somewhat more stringent communication needs with respect to communication-aware routing with application planning (for example, more stringent communication needs than supported by route 411). The example of route 412 includes some gaps in which wireless communication in accordance with the communication utilization information associated with UEs of or associated with the vehicle is not adequately supported, although still providing a somewhat direct route between origination 401 and destination 402. Route 412 may, for example, be well suited for applications with less elastic communication needs (for example, applications such as video streaming, VR, and AR).

Route 413 of FIG. 4 provides an example of a route associated with stringent communication needs with respect to communication-aware routing with application planning (for example, more stringent communication needs than supported by routes 411 and 412). The example of route 413 provides routing in which wireless communication in accordance with the communication utilization information associated with UEs of or associated with the vehicle is adequately supported without interruption, although providing a somewhat indirect route between origination 401 and destination 402. Route 413 may, for example, be well suited for applications with stringent communication needs (for example, applications such as autonomous driving, tele-operated driving, and gaming).

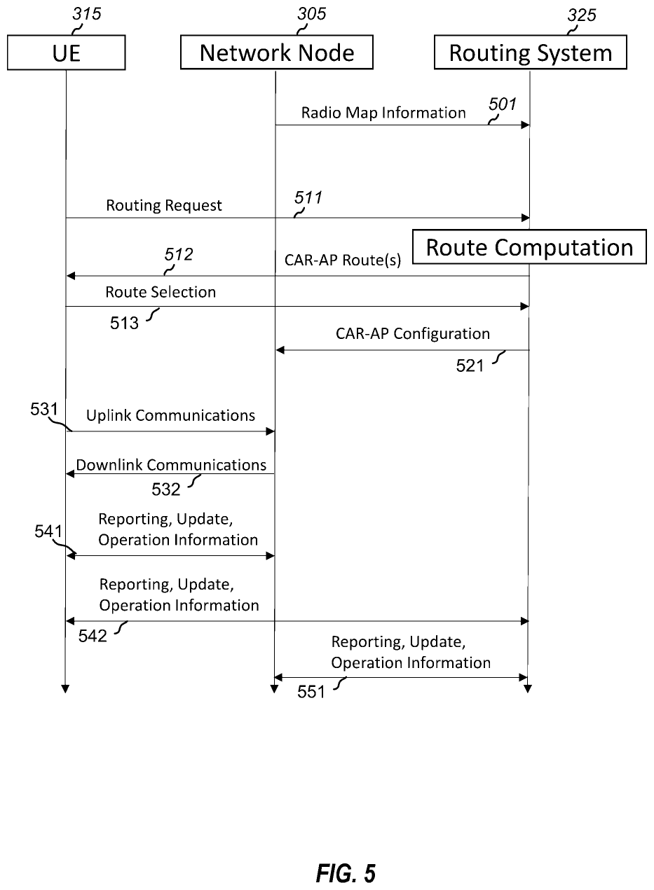

FIG. 5 is a ladder diagram illustrating example operations implemented for providing communication-aware routing with application planning according to one or more aspects. UE 315 shown in the example of FIG. 5 corresponds to UE 315 of FIG. 3 and may comprise a vehicle, one or more devices (for example, head device) associated with a vehicle, or any combination thereof configured to support communication-aware routing with application planning. Network node 305 shown in the example of FIG. 5 corresponds to network node 305 of FIG. 3 and may comprise an aggregated or disaggregated implementation of a network node configured to support communication-aware routing with application planning and providing wireless communications with respect to UEs operating in a wireless communications system. Routing system 325 shown in the example of FIG. 5 corresponds to routing system 325 of FIG. 3 and may comprise one or processor-based systems configured to support communication-aware routing with application planning.

In operation according to the example illustrated in FIG. 5, routing system 325 receives or otherwise obtains radio map information in communication 501 (for example, one or more messages of radio mapping message(s) 384) transmitted or otherwise provided by network node 305. Communication 501 may, for example, include radio environment information with respect to communications provided by or otherwise associated with network node 305. Communication 501 of some examples may include radio environment information with respect to communications provided by or otherwise associated with other network nodes (for example, one or more network nodes neighboring network node 305) in wireless communications system 300. Information of communication 501 may be utilized by routing system 325 (for example, as part of radio map information 329) with respect to radio map generation, updating, and maintenance. Accordingly, radio map information may, for example, be provided to or otherwise obtained by routing system 325 as part of a communication-based routing system initialization procedure, throughout operation of the routing system (for example, as update information), or a combination thereof.

Although the ladder diagram of FIG. 5 shows a single communication between network node 305 and routing system 325, it is to be understood that multiple such communications may be provided. For example, multiple instances of communication 501 may be implemented in association with initially configuring a radio map of or associated with radio map information 329 and in association with updating or otherwise maintaining the radio map. Further, a plurality of network nodes (for example, some or all of network nodes 305a, 305b, 305c, 305d, 305e, 305f, 305g, 305h, 305i, 305j, 305k, and 3051) may each similarly provide respective instances of communications including radio environment information with respect to communications provided by or otherwise associated with the network nodes.

Radio map information may be collected by network nodes, UEs, or a combination thereof as communications are implemented in wireless communications system 300. UEs (for example, UE 315) may obtain and provide radio map information to a network node (for example, network node 305), such as for relaying to routing system 325, from time to time as the UE performs communication operations within the wireless network. In addition to, or in the alternative to, network nodes providing radio map information to routing system 325, UEs (for example, UE 315) of some examples may provide radio map information (for example, as one or more messages of radio mapping message(s) 374) to routing system 325. Network nodes may additionally or alternatively obtain and provide radio map information to routing system 325.

Although not specifically shown in the example operations of FIG. 5, routing system 325 may receive or otherwise obtain HD map information (for example, one or more messages of HD mapping message(s) 383) transmitted or otherwise provided by network node 305, one or more messages of HD mapping message(s) 373 transmitted or otherwise provided by UE 315, or a combination thereof). HD map information (for example, data regarding roadway infrastructure and topology, lane boundaries, road signals, crosswalks, traffic lights, etc.) may be received by network node 305 from various vehicles and other sources traveling, monitoring, or otherwise associated with roadways of a service area (for example, provided in accordance with organized data collection, crowdsourced data collection, or a combination thereof). Network node 305, UE 315, or a combination thereof may provide HD map information (for example, in the form of raw data as obtained or monitored by the particular device or as processed or partially processed data, such as being aggregated, filtered, curated, etc.) to routing system 325 (for example, as part of HD mapping message(s) 373, HD mapping message(s) 383, or a combination thereof) with respect to HD map generation, updating, and maintenance. HD map information may, for example, be provided to or otherwise obtained by routing system 325 as part of a routing system initialization procedure, throughout operation of the routing system (for example, as update information), or a combination thereof.

Continuing with operation according to the example illustrated in FIG. 5, routing system 325 receives or otherwise obtains a routing request in communication 511 (for example, one or more routing request messages of CAR-AP initiation message(s) 371) transmitted or otherwise provided by UE 315. Communication 511 may, for example, include information regarding a trip to be made by or in association with UE 315. The routing request of communication 511 may, for example, be transmitted by a vehicle or other device (for example, UE 315) of or associated with the vehicle prior to the start of a trip to be made by the vehicle.

A routing request of communication 511 may include information regarding an origination point (for example, origination 401), a destination point (for example, destination 402), one or more way points (for example, intervening points of travel on route to the destination point), or a combination thereof. Additionally or alternatively, the routing request of communication 511 may include travel information, such as preference information (for example, routing preferences, communication preferences, etc.), travel needs, travel constraints, travel capabilities, etc. According to some examples, passengers may have a default travel information settings. Additionally or alternatively, various aspects of travel information may be set it in a routing application (for example, a routing application provided by CAR-AP logic 316) ahead of time. Preference information may, for example, include information regarding preferences of the passengers for different aspects of the trip experience, such as for better communication, or shorter trip. One or more preference of some examples may be indicted by an index (for example, 1 to 10).

The routing request of some examples includes application utilization information for use with respect to communication-aware routing with application planning according to aspects of the disclosure. Application utilization information may, for example, include information regarding number of passengers/devices in or associated with a vehicle to travel a route providing communication-aware routing with application planning, applications being active or expected to be active in association with the vehicle traveling the route (for example, applications in use or expected to be used by the vehicle itself, by devices associated with the vehicle, or a combination thereof), QoS needs with respect to the applications, etc.), or a combination thereof.

CAR-AP logic 316 of some aspects may identify or otherwise determine applications currently in use by one or more device (for example, UE 315) of or associated with a vehicle, may predict (for example, using historic application use information from previous trips, based upon applications currently in use, based upon the number of passengers or other passenger information, based upon number and type of devices in use or expected to be in use, etc.) use of one or more applications by a device or devices of or associated with the vehicle, or a combination thereof. Devices, applications in use or to be used by devices, or a combination thereof may be identified through devices being connected (for example, via device-to-device (D2D), BLUETOOTH, WIFI. sidelink, or other links) to a device of or otherwise associated with a vehicle. The devices may, for example, confirm each other as being in or associated with the same vehicle through message exchange. The message exchange may include an indication whether or not the strategies intended for communication-aware routing with application planning routed vehicles also apply to the device that is now associated with the vehicle. According to some examples, a user or users (for example, passengers) or other entity may additionally or alternatively input information regarding passengers, devices, applications, their current use, expected use, or any combination thereof. In an example, a device may present a choice regarding applications that are to be used, expected to be used, or may be used with respect to a trip as the device or another device is associated with the vehicle (for example, when passengers bearing devices enter the car, when devices connect via communication links within the vehicle, etc.). A passenger bearing a particular device may, for example, indicate the applications they will use, would like to use, etc. during the trip through a user interface of their device or of the vehicle.

Information regarding QoS needs with respect to the applications of the application utilization information of some examples may include information such as QoS needs for individual applications, combined QoS needs for applications, or a combination thereof. The information regarding QoS needs according some aspects may include information with respect to latency, reliability, number of packets received per minutes, etc., and may be provided with respect to uplink communications, downlink communications, or a combination thereof.

CAR-AP logic 316 of some aspects may analyze devices in use or to be used, applications in use or to be used, or a combination thereof in determining various aspects of QoS needs. According to some examples, a user or other entity may additionally or alternatively input information regarding QoS needs.

The routing request of some examples additionally or alternatively includes communication utilization information for use with respect to communication-aware routing with application planning according to aspects of the disclosure. Communication utilization information of a routing request may, for example, include information regarding communication use, communication needs, communication constraints, communication capabilities, communication resources, or any combination thereof.

CAR-AP logic 316 of some aspects may analyze devices in use or to be used, applications in use or to be used, or a combination thereof in determining various aspects of communication utilization information. According to some examples, a user or other entity may additionally or alternatively input information regarding communication utilization information.

Routing system 325 of the example of FIG. 5 operates to perform route computation operations, such as in response to or otherwise associated with a routing request of communication 511. For example, CAR-AP logic 326 of routing system 325 may generate one or more communication-aware routes with application planning based upon information in a routing request (for example, application utilization information, communication utilization information, etc.), such as by utilizing information of CAR-AP information 327, HD map information 328, and radio map information 329. CAR-AP logic 326 of some examples may consider wireless communication needs for or associated with the vehicle, wireless communication performance available along one or more routes, attributes of desired user experience, etc. to determine and generate one or more communication-aware routes for supporting or otherwise accommodating utilization of applications with the vehicle traveling the one or more routes. Computation of candidate routes may consider aspects of application utilization and communication utilization with respect to the downlink, the uplink, or a combination thereof.

Route computation operations performed by routing system 325 of some examples may include determinations regarding areas of the route supporting satisfactory or unsatisfactory communications, times for satisfactory or unsatisfactory communications, etc. with respect to various information (for example, download of information associated with one or more applications, upload of information associated with one or more applications, download of HD map information, upload of crowdsourced HD map information, upload of radio map information, etc.) regarding communication between devices of or associated with the vehicle traveling the route and network nodes located along the route. According to some examples, CAR-AP logic 326 may make determinations regarding road segments along the route, network nodes along the route, or a combination thereof at which information (for example, information associated with one or more applications, HD map information, etc.) may be satisfactorily communicated between UE 315 and network node 305. One or more network nodes located along the route prior to or after a network node providing poor radio coverage for the route may be identified for communication of some information (for example, information utilizing relatively high bandwidth, having high reliability needs, etc.). One or more communication-aware routes with application planning in accordance with aspects of the application utilization information, communication utilization information, or a combination thereof may be determined based on information provided from the determinations regarding areas of the route supporting satisfactory or unsatisfactory communications.

Communication-aware routes with application planning of some aspects of the disclosure are computed by routing system 325 to provide information in correspondence to roadway segments along the candidate route. For example, a communication-aware route with application planning may be segmented into segment lengths (for example, roadway length), segment widths (for example, roadway lanes), or a combination thereof, such as may be individually identified by a corresponding road segment ID (for example, as may be provided by HD map information 328, radio map information 329, or a combination thereof).

In an example in which more than one routes are included in a routing response, the routes may include one or more routes optimized with respect communication aspects. For example, one or more candidate routes may be computed to provide high communication quality, high communication rate, etc. throughout to support uninterrupted, reliable, and low-latency transmission of messages suitable for applications having stringent and seamless communication needs (for example, autonomous driving and tele-operated driving applications). Additionally or alternatively, one or more candidate routes may be computed to provide good and reliable communication quality, good and reliable communication rate, etc. throughout to support a minimum level of communication services to avoid latency or dropping suitable for applications having less stringent communication needs (for example, video streaming and gaming applications). One or more candidate routes may additionally or alternatively be computed to provide varying communication quality, varying communication rate, etc. throughout to support bursty high bandwidth communications suitable for applications having elastic communication needs (for example, web surfing, VR, and AR applications).

Routing system 325 transmits or otherwise provides a routing response in communication 512 (for example, one or more routing request messages of CAR-AP initiation message(s) 371) as may be received or otherwise obtained by UE 315. Communication 512 may, for example, include one or more communication-aware routes with application planning generated or otherwise determined utilizing information of a routing request made by or on behalf of UE 315.

In operation according to some examples, a routing response of communication 512 may include multiple candidate routes for selection (for example, by a passenger, through operation of CAR-AP logic 316 to identify and select a route having suitable attributes, etc.) for use with respect to travel to the destination point. In addition to the candidate routes, a routing response of some examples may include information facilitating an informed route selection from multiple candidate routes or otherwise informative with respect to aspects of one or more candidate routes. A routing response may, for example, include for each candidate route information with respect to the expected travel time, the expected arrival time, the average communication rate along the route, the portions of the route (for example, indicated by road segment IDs) where one or more communication needs cannot be satisfied, the particular applications that can be enabled along the route (for example, by application type, such as web browser, gaming application, video streaming application, VR application, etc., by identifying the applications, such as EDGE, NETFLIX, etc., or a combination thereof). In accordance with some examples, a routing response may include information (for example, an experience score or index) with respect to the expected user experience with respect to enabling one or more applications along the route. Such experience information may, for example, be with respect to the experience associated with downlink communication, the experience associated with uplink communication, or a combination thereof.

A routing response of communication 512 of some examples may include information regarding areas of the route supporting satisfactory or unsatisfactory communications. For example, routing system 325 may provide information to devices or a passenger of the vehicle regarding availability of HD map information associated with the route. HD map communication information (for example, the IP addresses of the network node, network node ID of the network node, identification information for the HD map or portion thereof to be obtained, road segment IDs for areas to be included in the HD map information to be obtained, etc.) may be provided (for example, one or more messages of CAR-AP initiation message(s) 371, one or more messages of HD mapping message(s) 373, etc.) to UE 315 regarding network nodes that may satisfactorily download the HD map information for road segments where the radio coverage is poor. Additionally or alternatively, HD map communication information may be provided to UE 315 regarding network nodes to which crowdsourced HD map information may be uploaded by UE 315.

According to the example of FIG. 5, for a situation in which a routing response includes multiple candidate routes, routing system 325 receives or otherwise obtains a routing selection in communication 513 (for example, one or more routing request messages of CAR-AP initiation message(s) 371) transmitted or otherwise provided by UE 315. Communication 513 may, for example, include information regarding a communication-aware route with application planning of multiple candidate routes computed by routing system 325 that has been selected by or in association with UE 315. The route selection of communication 513 may, for example, be transmitted by a vehicle or other UE in or associated with the vehicle prior to the start of a trip to be made by the vehicle.

Although not specifically shown in the example operations of FIG. 5, additional information regarding a selected route may be provided (for example, one or more messages of CAR-AP initiation message(s) 371) in response to selection of the route for travel. According to some examples, routing system 325 may provide UE 315 information regarding travel details for the selected route, such as the suggested speed and lanes on the selected route. Although communication of such travel details may be provided for all candidate routes of multiple candidate routes (for example, in or in association with a routing response) in some examples, communication of travel details may be provided in association with selection of a route according to some examples, such as to reduce communication bandwidth associated with communication-aware routing with application planning initiation.

The above described operation according to the example of FIG. 5, in which communications 511, 512, and 513 are exchanged between UE 315 and routing system 325, provides for communication-aware routing with application planning for vehicle travel in association with UE 315. According to some examples, the vehicle may itself comprise one or more devices (for example, a device comprising UE 315) each executing one or more applications for which communication-aware routing with application planning is to be provided, may have one or more devices (for example, a device comprising UE 315) associated therewith and each executing one or more applications for which communication-aware routing with application planning is to be provided, or a combination thereof. A particular device (for example, UE 315) of the devices of or associated with the vehicle may operate as a lead or head device, such as to initiate and manage communication-aware routing with application planning operation, to communicate CAR-AP initiation message(s) 371, to communicate HD mapping message(s) 373, to obtain application utilization information, to obtain communication utilization information, etc. In an example, a device of the vehicle (for example, a autonomous driving system or a vehicle navigation system) may serve as a head device with respect communication-aware routing with application planning operation. In another example, a device may be selected to serve as a head device according to head device selection rules (for example, a vote among devices or users, a random selection process, identification of a device having robust communication capabilities, processing capabilities, or a combination thereof, identification of a device having highest communication needs, etc.). CAR-AP logic 316 of a device selected to serve as a head device may initiate and control the above described messaging.

Continuing with operation according to the example illustrated in FIG. 5, routing system 325 transmits or otherwise provides communications-aware routing with application planning information in communication 521 (for example, one or more configuration messages of CAR-AP configuration message(s) 381) to be received or otherwise obtained by network node 305. Communication 521 may, for example, include information regarding a portion of a trip to be made by or in association with UE 315 that traverses an area for which communication services are provided by network node 305. The information of communication 521 may, for example, be transmitted to network node 305 prior to the start of a trip to be made by the vehicle, prior to entry by the vehicle of the area for which communication services are provided by the network node 305, etc. According to some examples, after computing and finalizing a route for a vehicle, routing system 325 may transmit configuration information to network nodes located along the route. A configuration information message of communication 521 may be an upper layer message, in the application layer, or a combination thereof.

Information of communication 521 may include information regarding configuring one or network nodes for supporting communication with respect to a vehicle and one or more UEs of or a associated with the vehicle when traversing a route provided according to communication-aware routing with application planning operation of aspects herein. Information (for example, in one or more messages of CAR-AP configuration message(s) 381) provided by routing system 325 to network node 305 of some examples may include reservation/priority information regarding communication resources of the network node for facilitating communications meeting aspects of application utilization information and communication utilization information associated with the vehicle.

In an example, the reservation/priority information may include one or more bandwidth reservation messages to reserve respective communication resources of the network node for wireless communication as the vehicle travels the route. Bandwidth reservation messages may, for example, include an indication of an amount of bandwidth reserved, information identifying the vehicle for which bandwidth is reserved, information identifying the wireless communication device(s) for which bandwidth is reserved, information identifying application(s) that are active or desired to become active and for which bandwidth is reserved in association with the vehicle traveling the route, information regarding a bandwidth reservation start time, information regarding a bandwidth reservation end time, or any combination thereof. According to some examples, a bandwidth reservation may be for uplink bandwidth, downlink bandwidth, or a combination thereof. For example, a first bandwidth reservation may be provided with respect to uplink communications and a second bandwidth reservation may be provided with respect to downlink communications.

Aspects of the communications-aware routing with application planning information may be adapted for implementation by the network node in correspondence with the vehicle traveling the route. For example, bandwidth reservation start time of an example may be provided to correspond to a time at which the vehicle is expected to enter an area for which communications is provided by the network node, a time at which the vehicle is expected to traverse a segment of roadway corresponding to the reserved resources, etc. Similarly, bandwidth reservation end time of an example may be provided to correspond to a time at which the vehicle is expected to exit an area for which communication is provided by the network node, a time at which the vehicle is expected to traverse a segment of roadway corresponding to the reserved resources, etc.

According to some aspects of the disclosure, resource reservations of the reservation/priority information may be implemented based on network slicing technology. For example, network slicing may be utilized to create multiple logical networks on top of a common shared physical network, such that one or more parts of the network may be segmented for the use with respect to the vehicle.

Although examples of reservation/priority information including bandwidth reservation messages are provided above, some examples may provide for resource reservation in addition to or in the alternative to bandwidth reservation. For example, resource reservations may be provided based upon time resources (for example, frames, sub-frames, slots, etc.), frequency resources (for example, physical channels, subcarriers, etc.).

In a further example, reservation/priority information may include one or more communication resource priority messages to establish communication priority with respect to wireless communication associated with the vehicle as the vehicle travels the route. According to some examples, communication resource priority messages may establish data communication priority for wireless communication with respect to the vehicle as the vehicle travels the route. Communication resource priority messages may, for example, include uplink priority information, downlink priority information, information identifying the vehicle, information identifying the wireless communication device, information identifying a communication device other than the wireless communication device associated with the vehicle, information identifying an application that is active or desired to become active in association with the vehicle traveling the route, or any combination thereof. According to some examples, a communication resource priority may be for uplink bandwidth, downlink bandwidth, or a combination thereof. For example, a first communication resource priority may be provided with respect to uplink communications and a second communication resource priority may be provided with respect to downlink communications.

Aspects of the communications-aware routing with application planning information may be adapted for implementation by the network node in correspondence with multiple vehicles traveling communication-aware routes with application planning. For example, a number of high priority vehicles per network node may be preconfigured for each network node (for example, as part of an initial deployment configuration or periodic network configuration procedure, in configuration information of a message of CAR-AP configuration message(s) 381, etc.). In operation according to some examples, routing system 325 may receive or otherwise obtain a resource priority response message (for example, one or more messages of CAR-AP configuration message(s) 381) transmitted or otherwise provided by network node 305. For example, a resource priority response message provided in association with transmission of a communication resource priority message may include information indicating the network node is oversubscribed with respect to communication resource priority grants having conflicting communication priority (for example, communication priority established prior to the communication resource priority message, communication priority higher than the communication priority to be established according to the communication resource priority message, etc.) with respect to the communication priority to be established according to the communication resource priority message. According to some examples, routing system 325 (for example, under control of CAR-AP logic 326) may, in association with receiving the resource priority response message, alter an aspect of the route in correspondence with the radio map. For example, the route may be updated to change a portion of the route for an area in which suitable communication resource priority is available, the resource communication priority with respect to one or more vehicles may be updated to accommodate communication needs, etc.

The vehicle traveling the route may utilize aspects of HD map information (for example, HD map information 318 of UE 315), such as to implement an autonomous driving mode of an autonomous driving application. According to some examples, HD map information may be provided to vehicles by one or more systems of a routing system (for example, routing system 325), one or more network nodes located along the route (for example, network node 305), one or more edge devices, or a combination thereof. The HD map information may be stored in these systems (for example, HD map information 328, HD map information 308, etc.), or may be stored in the cloud. An autonomous vehicle operating in autonomous driving mode may, for example, need to receive HD maps (for example, highly detailed, highly accurate maps that represent location data including various features, such as lane markings, road edges, signage, etc., not typically found) prior to the vehicle entering the area corresponding to the map. Aspects of the communications-aware routing with application planning information may be adapted for facilitating communication of HD map information to the vehicle, such as prior to the vehicle entering the area corresponding to the map.

Information (for example, in one or more messages of CAR-AP configuration message(s) 381 of communication 521) provided by routing system 325 to network node 305 of some examples may include HD map communication information for facilitating communication of HD map information with respect to a vehicle traveling the route.

In operation according to some examples of communication-aware routing with application planning herein, route computation operations performed by routing system 325 may perform HD map information communication computation operations for facilitating communication of HD map information. For example, CAR-AP logic 326 of routing system 325 may identify portions of a route (for example, segments of roadways identified by corresponding road segment IDs) that have poor radio coverage (for example, unsatisfactory or undesirable communication quality, communication latency, signal reception conditions, signal transmission conditions, QoS, etc.) or otherwise may be unsuitable for reliable and timely communication of HD map information to a vehicle traveling the route, such as utilizing information of CAR-AP information 327, HD map information 328, and radio map information 329.

As described above, CAR-AP logic 326 may make determinations (for example, road segments along the route at which information may be satisfactorily communicated, network nodes located along the route suitable for communicating information to the vehicle, etc.) regarding communication of information (for example, HD map information) between network nodes and a vehicle traveling the route. According to some examples, one or more network nodes located along the route prior to a network node providing poor radio coverage for the route may be identified for transmission of HD map information corresponding to one or more road segment of an area for which communications are provided by the network node providing poor radio coverage. Aspects of HD map communication information may, for example, provide information to coordinate communication of HD map information to the vehicle before the vehicle enters an area with poor radio coverage.

HD map communication information of some examples may include communication resource reservation information (for example, one or more bandwidth reservation messages), such as to reserve extra bandwidth or other communication resources of one or more network nodes located along the route prior to a network node providing poor radio coverage, to facilitate HD map communication information (for example, one or more messages of CAR-AP configuration message(s) 381 of communication 521) may, for example, indicate road segments (for example, indicated by road segment ID) in the upcoming route that has poor radio coverage, such that network node 305 may determine the corresponding HD map information to transmit to the vehicle.

In some examples, network node 305 may have information (for example, included in HD map information 308) regarding the HD maps corresponding to other network nodes (for example, neighbor network nodes, network nodes having poor radio coverage, etc.). In some examples in which network node 305 may not have information, or sufficient information, regarding the HD maps corresponding to other network nodes, network node 305 may send request messages to the corresponding network nodes for the respective HD map information. According to some examples, the HD map communication information provided to network node 305 by routing system 325 may include information (for example, network node IDs, the Internet protocol (IP) addresses of the network nodes, etc.) regarding which network nodes store or otherwise have access to the HD map information to be obtained by network node 305. Network node 305 may use this information to provide a HD map information request to one or more network nodes storing or otherwise having access to the HD map information to be obtained by network node 305 to coordinate communication of the appropriate HD map information to network node 305.

Additionally or alternatively, routing system 325 may provide HD map communication information to one or more network nodes storing or otherwise having access to the HD map information to be obtained by network node 305 to request or otherwise coordinate communication of the appropriate HD map information to network node 305. The HD map communication information may include information (for example, the IP addresses of the source network node, the IP address of network node 305 as the destination network node, network node ID of the source network node, network node ID of network node 305 as the destination network node, identification information for the HD map or portion thereof to be communicated, road segment IDs for areas to be included in the HD map information communicated to network node 305, etc.) to facilitate communication of the HD map information. Less network signaling may be utilized for HD map information communication in an example in which routing system 325 provides a HD map information request to a source network node for providing HD map information to network node 305, as compared to network node 305 providing the requests to one or more network nodes storing or otherwise having access to the HD map information.

In operation according to the example of FIG. 5, UE 315 may travel a route for which communication services are provided by one or more network nodes (for example, network node 305) in accordance with communication-aware routing with application planning determined by routing system 325. For example, the route may comprise a communication-aware route with application planning of multiple candidate routes computed by routing system 325 that has been selected by or in association with UE 315. Desired aspects of wireless communication (for example, one or more uplink messages of application message(s) 395 in communication 531, one or more downlink messages of application message(s) 395 in communication 532, or a combination thereof) associated with the various devices and applications of or associated with the vehicle are facilitated as the vehicle travels the route as a result of the communication-aware routing with application planning. According to some examples, the communications associated with one or more network nodes located along the route corresponding to one or more road segments of the route may be provided according to resource reservation information, communication priority information, or a combination thereof for supporting communication-aware routing with application planning with respect to the vehicle.

Various conditions along a route may not be as expected or planned when the vehicle actually travels the route, which may impact communications of a communication-aware route with application planning. For example, traffic congestion may slow down the vehicle, such as may result in changes in communication demand in areas of the route, resource reservations, priorities, etc. being misaligned with vehicle progress along the route, extended presence by the vehicle in an area of good or poor radio coverage, etc. As another example, one or more new applications, which were not considered when a communication-aware route with application planning was determined, may be launched or otherwise utilized by a device of or associated with the vehicle while traveling the route. In yet another example, one or more new passengers/devices, which were not considered when a communication-aware route with application planning was determined, may associate with (for example, enter) the vehicle while in route. Such new applications and passengers/devices may result in changes in application utilization information (for example, QoS needs with respect to the applications, etc.), communication utilization information (for example, applications being active in association with the vehicle traveling the route, communication resources, capabilities constraints, needs, utilization, etc.), etc.

In operation according to some examples, UE 315 may provide update information regarding various conditions (for example, traffic congestion or associated delay, new applications, new passengers/devices, HD map information, radio map information, etc.) experienced along the route. Update information may be provided (for example, one or more messages of CAR-AP update message(s) 372, HD mapping message(s) 373, radio mapping message(s) 374, or a combination thereof in communication 542) by UE 315 to routing system 325. Update information may, for example, be provided to routing system 325 to facilitate suitable communication of information (for example, application information, HD map information, or a combination thereof) with respect to the vehicle, to facilitate updating one or more aspects of a communication-aware route with application planning so as to provide an updated route for supporting or otherwise accommodating utilization of applications with the vehicle traveling the route, etc. According to some examples, a device associated with the vehicle (for example, the head device) may provide an updated routing request providing information regarding a QoS needs change, new applications started by the passengers, etc.

Additionally or alternatively, update information may be provided (for example, one or more update messages of CAR-AP update message(s) 392, HD mapping message(s) 393, radio mapping message(s) 394, application message(s) 395, or a combination thereof in communication 541) by UE 315 to network node 305. Update information may, for example, be provided to network node 305 for relaying to routing system 325, to facilitate suitable communication of information (for example, application information, HD map information, etc.) with respect to the vehicle, to facilitate updating one or more aspects of a communication-aware route with application planning, etc. Network node 305 of some examples may utilize information, such as a table or other database, regarding bandwidth each application typically utilizes in combination with one or more aspects of update information in updating communications provided with respect to the vehicle.

Additionally or alternatively, network node 305 may provide update information regarding various conditions (for example, traffic congestion or associated delay, new applications, new passengers/devices, etc.) associated with the vehicle traveling the route. Update information may be provided (for example, one or more messages of CAR-AP update message(s) 382, HD mapping message(s) 383, radio mapping message(s) 384, or a combination thereof in communication 551) by network node 305 to routing system 325. Update information may, for example, be used to facilitate suitable communication of information (for example, application information, HD map information, etc.) with respect to the vehicle, to facilitate suitable communication of information (for example, application information, HD map information, etc.) with respect to the vehicle, to facilitate updating one or more aspects of a communication-aware route with application planning, etc. According to some examples, network node 305 may provide information regarding a QoS needs change, new applications started by the passengers, delay of the vehicle traversing the route, etc.

Although the foregoing examples of further information provided between network node 305, UE 315, and routing system 325 describe instances of update information, it should be understood that further information communicated via any or all of communications 541, 542, and 551 may comprise information in addition to or in the alternative to update information. Some examples of communications 541, 542, and 551 may provide for exchange of various information, such as reporting information (for example, CAR-AP reporting, sensing/measurement reporting, location reporting, etc.), update information (for example, CAR-AP updates, vehicle/device status updates, traffic condition updates, etc.), operational information (for example, scheduling, resource allocation, etc.). For example, communication 541 of some examples may comprise information regarding resource allocation/reallocation from network node 305 to UE 315. In another example, communication 542 may comprise information regarding car accident information from routing system 325 to UE 315. In still another example, communication 551 may comprise information regarding scheduling with respect to one or more vehicles/devices from routing system 325 to network node 305. As should be understood from the foregoing, any or all of communications 541, 542, and 551 may provide uplink communications, downlink communications, or a combination thereof.

According to some examples, the update information provided by UE 315, network node 305, or both may use signaling/messages configured the same or similar to those (for example, messages of CAR-AP initiation message(s) 371, CAR-AP configuration message(s) 381, etc.) utilized in initially determining the communication-aware routing with application planning. For example, signaling/message format and content may correspond to that of the previous signaling/messaging revised to include one or more aspects of the update information. According to some examples, signaling/messages used with respect to the update information may implement a delta or difference signaling technique, such as by keeping track of changes of the update information and providing one or more aspects of those changes in the signaling/messages for update information. The update information may include various identification information (for example, device ID, application ID, network node ID, road segment ID, etc.) associated therewith, such as may be utilized in identifying particular aspects of communication-aware routing with application planning the update information applies to.

Routing system 325 of some examples may revise or otherwise alter one or more aspects of communication-aware routing with application planning with respect to devices of or associated with the vehicle, the network node, or a combination thereof. For example, CAR-AP logic 326 of routing system 325 (for example, utilizing aspects of the update information, such as with information of CAR-AP information 327, HD map information 328, radio map information 329, etc.) may update a communication-aware route with application planning based on changes (for example, traffic delays or moving at increased speeds, accidents, network nodes along the route experiencing more poor or better network conditions, increased or decreased numbers of autonomous/network connected vehicles along the route, etc.) experienced along a route as traveled by a vehicle or as are otherwise not as expected or planned. As another example, CAR-AP logic 326 of routing system 325 may recompute bandwidth reservations associated with the vehicle based upon traffic congestion condition changes indicated by the update information.

According to some examples, update information may be provided to network node 305, routing system 325, or a combination thereof for use in addition to or other than altering aspects of communication-aware routing with application planning associated with the vehicle traveling the route. For example, routing system 325 may collect the update information for revising aspects of other information (for example, CAR-AP information 327, HD map information 328, radio map information 329, historic application use information, etc.) utilized with respect to future communication-aware routing with application planning. According to some examples, a setting (for example, a preference setting provided in association with a vehicle or devices associated therewith, a configuration setting of routing system 325, etc.) may be provided, whereby one or more aspects (for example, traffic congestion or associated delay, new applications, new passengers/devices, etc.) of update information may not initiate altering aspects of communication-aware routing with application planning (for example, an updated route may not be determined in response to update information provide by or in association with a vehicle).

In operation according to some examples, a request may be provided to a network node when an update to the HD map in use with respect to the vehicle is needed. For example, UE 315 may provide an HD map information request (for example, a message of HD mapping message(s) 393) to network node 305 in response to a determination (for example, by CAR-AP logic 316) that updated/additional HD map information is needed, in anticipation of entering an area having poor radio coverage associated therewith, in association with traffic congestion providing an extended opportunity for download of updated/additional HD map information, etc. The HD map information request may, for example, include information regarding how far ahead along the route the requested HD map information is to include, an indication that the requested HD map information is to include information for some or all road segments for which communication services are provided by this network node, an indication that the requested HD map information is to include information for some or all road segments for which communication services are provided by one or more network nodes other than this network node (for, example, a next or otherwise subsequent network node located along the route), or a combination thereof. If the network node does not have the requested HD map information (for example, stored in HD map information 308), the network node may provide a request (for example, a message of HD mapping message(s) 383) for that HD map information to one or more systems (for example, routing system 325, another instance of a network node, such as another network node located along the route, etc.) for HD map information.

According to some examples, a network node may initiate communication to provide an update to the HD map in use with respect to the vehicle. For example, network node 305 may determine (for example, by CAR-AP logic 306) that updated/additional HD map information (for example, a message of radio mapping message(s) 394) is to be provided to UE 315, such as in anticipation of the vehicle entering an area having poor radio coverage associated therewith, in association with traffic congestion providing an extended opportunity for download of updated/additional HD map information, etc. Network node 305 may, for example, determine that updated/additional HD map information is to be provided to UE 315 based on the network node having information regarding the route of the vehicle, the location of the network node along the route, QoS expected or predicted with respect to road segments along the route, channel conditions for communications with respect to the UE, progression of the UE along the route, information identifying a model or type of device/vehicle, etc.

According to some examples, network node 305 has information regarding radio coverage (for example, information of CAR-AP information 307, HD map information 308, etc. comprising information regarding communication quality, communication latency, signal reception conditions, signal transmission conditions, QoS, etc.) or is otherwise able to obtain or predict such information, such as for use in initiating communication to provide an update to the HD map in use with respect to the vehicle. Information regarding the vehicle (for example, vehicle type/model, capabilities of the vehicle type/model, location of the vehicle, etc.) may be used by network node 305, such as in combination with information regarding radio coverage, in association with the vehicle traveling the route, such as in initiating communication to provide an update to the HD map in use with respect to the vehicle.

A network node of some examples may provide control or coordination of information with respect to vehicles in addition or in alternative to the updated/additional HD map information described above. For example, network node 305 may control or coordinate communication of various information in the uplink, downlink, or a combination thereof with respect to devices of or associated with one or more vehicles operating within wireless communications system 300. According to some examples, network node 305 may determine (for example, by CAR-AP logic 306) what information to provide to a vehicle, when to provide information to a vehicle, when to change one or more aspects of communication associated with a vehicle, etc., such as based on the need for data, the data priority, the speed of the vehicle(s) (for example, average vehicle speed(s)), the traffic condition (for example, a vehicle in a congested area may delay upload/download of data), etc. For example, network node 305 may determine which vehicle sends/receives first, when and where crowdsourcing uploading/downloading happens, etc. In operation according to some examples, network node 350 may utilize one or more metrics (for example, HD map change thresholds, vehicle speed thresholds, radio coverage thresholds, traffic congestion indices, etc.) with respect to providing control or coordination of information communication.

As described with reference to FIGS. 3 and 5, the present disclosure provides techniques for routing vehicles for supporting communication when traveling between locations. Communication-aware routing having application planning according to examples above facilitates one or more desired aspects of wireless communication with respect to various applications, such as autonomous driving applications, tele-operated driving applications, relatively high bandwidth applications, etc., in association with traversal of the route. The communication-aware routing with application planning of above examples may accommodate applications having different communication utilization needs, such as to be more efficient for applications with elastic communication needs, to enable reliable communication for applications with stringent communication needs, or a combination thereof.

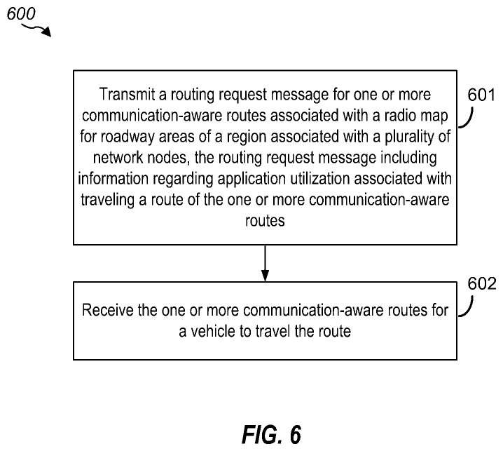

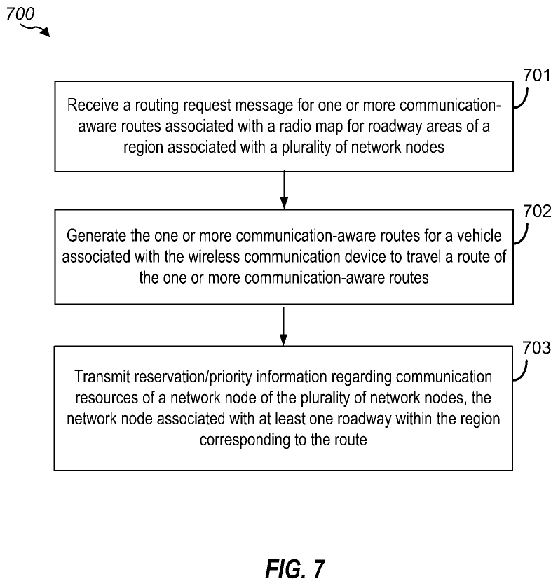

FIGS. 6 and 7 are flow diagrams illustrating example processes that support communication-aware routing with application planning according to one or more aspects. Operations performed in accordance with the example processes of FIGS. 6 and 7 may, for example, implement aspects of communication-aware routing with application planning described above with reference to FIGS. 3, 4, and 5.

Referring first to FIG. 6, an example process 600 that supports communication-aware routing with application planning according to one or more aspects is shown. Operations of process 600 may be performed by implementations of a UE, such as UE 115 described above with reference to FIGS. 1 and 2, or UE 315 described with reference to FIGS. 3, 4, and 5. For example, example operations (also referred to as “blocks”) of process 600 may enable UE 315 to support communication-aware routing with application planning.

In block 601, the UE transmits a routing request message for one or more communication-aware routes associated with a radio map for roadway areas of a region associated with a plurality of network nodes, the routing request message including information regarding application utilization associated with traveling a route of the one or more communication-aware routes. UE 315 may, for example, transmit a routing request message for one or more communication-aware routes to routing system 325. According to some examples, a routing request message may be transmitted to routing system 325 by UE 315 via one or more network nodes (for example, network node 305). The routing request message of some examples may include information regarding an origination point, a destination point, one or more way points, travel information, travel needs, travel constraints, travel capabilities, communication information, application utilization information, or any combination thereof.

In block 602, the UE receives the one or more communication-aware routes for a vehicle to travel the route. UE 315 may, for example, receive one or more communication-aware routes for a vehicle of or associated with UE 315 to ravel from routing system 325. According to some examples, the one or more communication-aware routes may be received from routing system 325 by UE 315 via one or more network nodes (for example, network node 305). Communication-aware routes of the one or more communication-aware routes may comprise candidate communication-aware routes with application planning configured to facilitate traveling between locations and considering communication information and application utilization information with respect to traveling the route. The one or more communication-aware routes, or information provided in association therewith, may include information (for example, expected travel time, expected arrival time, average communication rate along the route, portions of the route where one or more communication needs cannot be satisfied, particular applications that can be enabled along the route, information regarding areas of the route supporting satisfactory or unsatisfactory communications, or a combination thereof), such as for facilitating an informed route selection from multiple candidate routes, for facilitating obtaining HD map information, etc.

Although not shown in the example of process 600 illustrated in FIG. 6, in accordance with some aspects, the UE may transmit a routing selection message. UE 315 may, for example, transmit a routing selection message to routing system 325 in association with receiving the one or more communication-aware routes. According to some examples, a routing selection message may be transmitted to routing system 325 by UE 315 via one or more network nodes (for example, network node 305). The routing selection message of some examples may include information regarding a communication-aware route with application planning of multiple candidate routes computed by routing system 325 that has been selected by or in association with UE 315.

Referring now to FIG. 7, an example process 700 that supports communication-aware routing with application planning according to one or more aspects is shown. Operations of process 700 may be performed by a routing system, such as routing system 325 described above with reference to FIGS. 3, 4, and 5. For example, example operations of process 700 may enable routing system 325 to support communication-aware routing with application planning.

At block 701, the routing system receives a routing request message for one or more communication-aware routes associated with a radio map for roadway areas of a region associated with a plurality of network nodes. Routing system 325 may, for example, receive a routing request message for one or more communication-aware routes from a wireless communication device, such as UE 315. According to some examples, a routing request message may be received by routing system 325 from UE 315 via one or more network nodes (for example, network node 305). The routing request message of some examples may include information regarding an origination point, a destination point, one or more way points, travel information, travel needs, travel constraints, travel capabilities, communication information, application utilization information, or any combination thereof.

At block 702, the routing system generates the one or more communication-aware routes for a vehicle associated with the wireless communication device to travel a route of the one or more communication-aware routes. Routing system 325 may, for example, generate the one or more communication-aware routes in association with (for example, in response to) receiving the routing request message. According to some examples, one or more communication-aware routes with application planning may be generated based upon information in a routing request (for example, application utilization information, communication utilization information, etc.). According to some examples, routing system 325 may utilize aspects of the foregoing information in combination with one or more aspects of information of CAR-AP information 327, HD map information 328, radio map information 329, or a combination thereof. Generation of communication-aware routes with application planning may consider wireless communication needs for or associated with the vehicle, wireless communication performance available along one or more routes, attributes of desired user experience, etc. for supporting or otherwise accommodating utilization of applications with the vehicle traveling the one or more routes. Route computation operations of some examples may include determinations regarding areas of the route supporting satisfactory or unsatisfactory communications, times for satisfactory or unsatisfactory communications, etc. According to some examples, route computation operations may make determinations regarding road segments along the route, network nodes along the route, or a combination thereof at which information may be satisfactorily communicated between UE 315 and network node 305. Communication-aware routes with application planning of some aspects of the disclosure are computed by routing system 325 to provide information in correspondence to roadway segments (for example, by road segment ID) along the candidate route.

At block 703, the routing system transmits reservation/priority information regarding communication resources of a network node of the plurality of network nodes, the network node associated with at least one roadway within the region corresponding to the route. Routing system 325 may, for example, transmit the reservation/priority information in association with (for example, in response to) receiving the routing request message, generating the one or more communication-aware routes, or a combination thereof. According to some examples, reservation/priority information may be configured for facilitating communications meeting aspects of application utilization information and communication utilization information associated with the vehicle. Reservation/priority information may, for example, include one or more bandwidth reservation messages to reserve respective communication resources of the network node for wireless communication as the vehicle travels the route. Additionally or alternatively, reservation/priority information may include one or more communication resource priority messages to establish communication priority with respect to wireless communication associated with the vehicle as the vehicle travels the route.

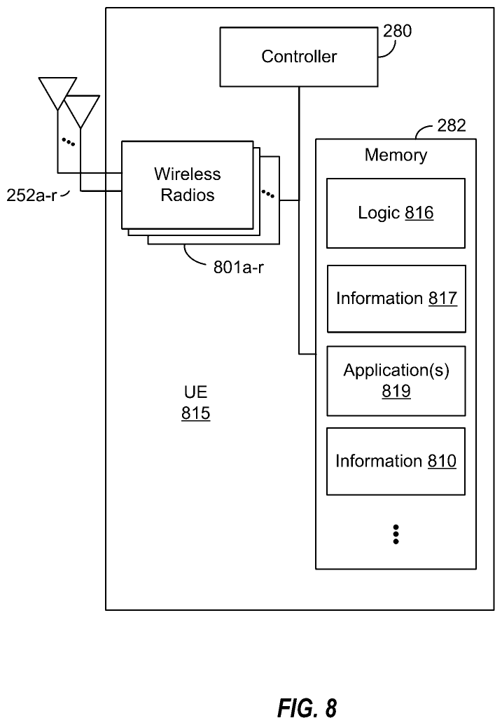

FIG. 8 is a block diagram of an example UE 815 that supports communication-aware routing with application planning according to one or more aspects. UE 815 may be configured to perform operations, including the blocks of a process described with reference to FIGS. 3, 5, and 6. In some implementations, UE 815 includes the structure, hardware, and components shown and described with reference to UE 115 of FIGS. 1 and 2, UE 315 of FIGS. 3, 4, and 5, or a combination thereof. For example, UE 815 includes controller 280, such as may include processor 311, which operates to execute logic or computer instructions stored in memory 282, as well as controlling the components of UE 815 that provide the features and functionality of UE 815. UE 815, under control of controller 280, transmits and receives signals via wireless radios 801a-r and antennas 252a-r. Wireless radios 801a-r of some examples include various components and hardware, as illustrated in FIG. 2 for UE 115, including modulator and demodulators 254a-r, MIMO detector 256, receive processor 258, transmit processor 264, and TX MIMO processor 266. Wireless radios 801a-r of some examples include transmitter 312, receiver 313, or a combination thereof. Some examples of UE 815 may include a network interface (not shown, such as may comprise a network interface card (NIC), broadband communication interface, etc., and combinations thereof, configured for supporting communications with respect to UE 815) operable for receiving signals from or transmitting signals to one or more network entities.

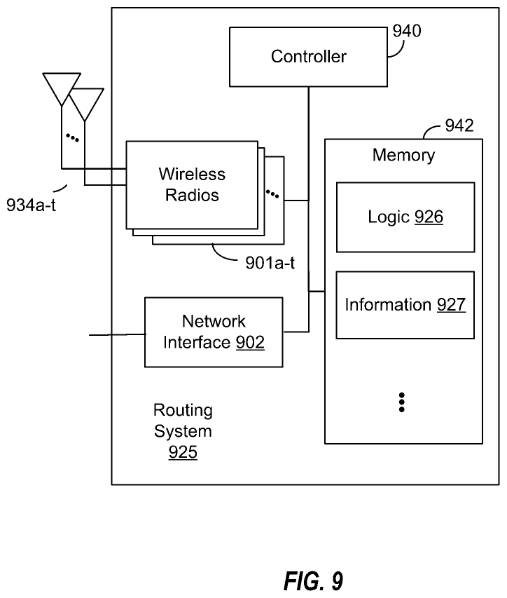

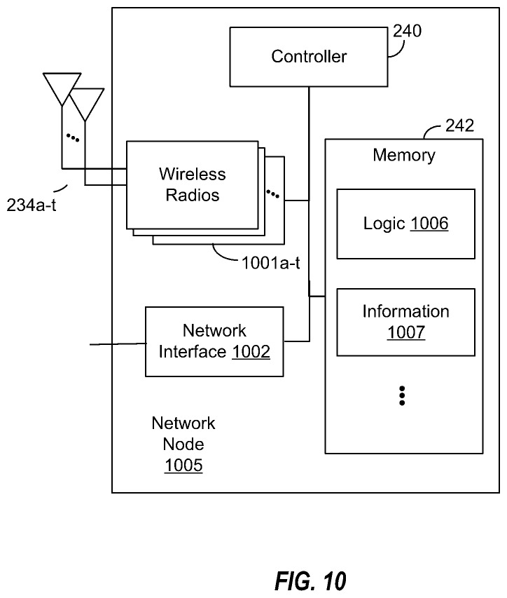

As shown, memory 282 may include logic 816, information 817, application(s) 819, and information 810. Logic 816 of some examples is configured to provide operations performed by UE 815 supporting communication-aware routing with application planning. Logic 816 may, for example, include logic corresponding to CAR-AP logic 316 described above. Information 817 of some examples is configured to provide information utilized (for example, by or with logic 816) in association with communication-aware routing with application planning. Information 817 may, for example, include information corresponding to CAR-AP information 317, HD map information 318, or a combination thereof. Information 817 may include additional or alternative information, such as radio map information, update information, etc., utilized in association with communication-aware routing with application planning. Application(s) 819 of some examples comprise one or more applications executable by or under control of controller 280 to provide functionality of UE 815. One or more applications of application(s) 819 may be utilized during or in association with traversal of a communication-aware route with application planning by a vehicle traveling the route. Information 810 may include information utilized by or in association with one or more applications of application(s) 819. UE 815 may receive signals from or transmit signals to one or more network entities, such as network node 105 of FIGS. 1 and 2, network node 305 of FIGS. 3, 4, and 5, network node 1005 of FIG. 10, routing system 325 of FIGS. 3 and 5, routing system 925 of FIG. 9, or any combination thereof.

FIG. 9 is a block diagram of an example routing system 925 that supports communication-aware routing with application planning according to one or more aspects. Routing system 925 may be configured to perform operations, including the blocks of a process described with reference to FIGS. 3, 5, and 7. Although shown as a separate system in the example of FIG. 9, routing system 925 of some examples may comprise various configurations, such as a network core system, an edge computing system, a system integrated into one or more network nodes, or a combination thereof. In some implementations, routing system 925 includes the structure, hardware, and components similar to or corresponding to that of a network node, such as that shown and described with reference to network node 105 of FIGS. 1 and 2, routing system 325 of FIGS. 3 and 5, or a combination thereof. For example, routing system 925 may include controller 940, such as may include processor 321, which operates to execute logic or computer instructions stored in memory 942, as well as controlling the components of routing system 925 that provide the features and functionality of routing system 925. Routing system 925, under control of controller 940, transmits and receives signals via wireless radios 901a-t and antennas 934a-t. Wireless radios 901a-t may include various components and hardware, as illustrated in FIG. 2 for network node 105, including modulator and demodulators 232a-t, transmit processor 220, TX MIMO processor 230, MIMO detector 236, and receive processor 238. Wireless radios 901a-t of some examples include transmitter 322, receiver 323, or a combination thereof. Routing system 925 of the illustrated example includes network interface 902, such as may comprise a NIC, broadband communication interface, backhaul communication interface, etc., and combinations thereof, configured for supporting communications with respect to routing system 925.

As shown, the memory 942 may include logic 926 and information 927. Logic 926 of some examples is configured to provide operations performed by routing system 925 supporting communication-aware routing with application planning. Logic 926 may, for example, include logic corresponding to CAR-AP logic 326 described above. Information 927 of some examples is configured to provide information utilized (for example, by or with logic 926) in association with communication-aware routing with application planning. Information 927 may, for example, include information corresponding to CAR-AP information 327, HD map information 328, radio map information 329, or a combination thereof. Information 927 may include additional or alternative information, such as update information, etc., utilized in association with communication-aware routing with application planning. Routing system 925 may receive signals from or transmit signals to one or more network entities, such as UE 115 of FIGS. 1 and 2, UE 315 of FIGS. 3, 4, and 5, UE 815 of FIG. 8, network node 105 of FIGS. 1 and 2, network node 305 of FIGS. 3, 4, and 5, network node 1005 of FIG. 10, or any combination thereof) via one or more wireless radios 901a-t. Additionally or alternatively, routing system 925 may receive signals from or transmit signals to one or more network entities via network interface 902.

FIG. 10 is a block diagram of an example network node 1005 that supports communication-aware routing with application planning according to one or more aspects. Network node 1005 may be configured to perform operations, including the blocks of a process described with reference to FIGS. 3 and 5. Although shown as a separate system in the example of FIG. 10, network node 1005 of some examples may comprise various configurations, such as an aggregated network node or a disaggregated network node. In some implementations, network node 1005 includes the structure, hardware, and components shown and described with reference to network node 105 of FIGS. 1 and 2, network node 305 of FIGS. 3 and 5, or a combination thereof. For example, network node 1005 may include controller 240, such as may include processor 301, which operates to execute logic or computer instructions stored in memory 242, as well as controlling the components of network node 1005 that provide the features and functionality of network node 1005. Network node 1005, under control of controller 240, transmits and receives signals via wireless radios 1001a-t and antennas 234a-t. Wireless radios 1001a-t include various components and hardware, as illustrated in FIG. 2 for network node 105, including modulator and demodulators 232a-t, transmit processor 220, TX MIMO processor 230, MIMO detector 236, and receive processor 238. Wireless radios 1001a-t of some examples include transmitter 302, receiver 303, or a combination thereof. Network node 1005 of the illustrated example includes network interface 1002, such as may comprise a NIC, broadband communication interface, backhaul communication interface, etc., and combinations thereof, configured for supporting communications with respect to network node 1005.

As shown, the memory 242 may include logic 1006 and information 1007. Logic 1006 of some examples is configured to provide operations performed by network node 1005 supporting communication-aware routing with application planning. Logic 1006 may, for example, include logic corresponding to CAR-AP logic 306 described above. Information 1007 of some examples is configured to provide information utilized (for example, by or with logic 1006) in association with communication-aware routing with application planning. Information 1007 may, for example, include information corresponding to CAR-AP information 307, HD map information 308, or a combination thereof. Information 1007 may include additional or alternative information, such as radio map information, update information, etc., utilized in association with communication-aware routing with application planning. Network node 1005 may receive signals from or transmit signals to one or more network entities, such as UE 115 of FIGS. 1 and 2, UE 315 of FIGS. 3, 4, and 5, UE 815 of FIG. 8, routing system 325 of FIGS. 3 and 5, routing system 925 of FIG. 9, or any combination thereof via one or more wireless radios 1001a-t. Additionally or alternatively, network node 305 may receive signals from or transmit signals to one or more network entities via network interface 802.

It is noted that one or more blocks (or operations) described with reference to FIGS. 6 and 7 may be combined with one or more blocks (or operations) described with reference to another of the figures. For example, one or more blocks (or operations) of FIG. 6 may be combined with one or more blocks (or operations) of FIG. 7. As another example, one or more blocks associated with FIG. 6, FIG. 7, or both may be combined with one or more blocks associated with FIG. 5. As another example, one or more blocks associated with FIG. 6, FIG. 7, or both may be combined with one or more blocks (or operations) associated with FIGS. 1-3. Additionally, or alternatively, one or more operations described above with reference to FIGS. 1-3 may be combined with one or more operations described with reference to FIG. 8, FIG. 9, FIG. 10, or any figure thereof.

Implementation examples are described in the following numbered aspects:

Aspect 1 Methods, apparatuses, and articles for wireless communication may provide for receiving, from a wireless communication device, a routing request message for one or more communication-aware routes associated with a radio map for roadway areas of a region associated with a plurality of network nodes, generating, in association with receiving the routing request message, the one or more communication-aware routes for a vehicle associated with the wireless communication device to travel a route of the one or more communication-aware routes, and transmitting, in association with receiving the routing request message, reservation/priority information regarding communication resources of a network node of the plurality of network nodes, the network node associated with at least one roadway within the region corresponding to the route.

Aspect 2. The methods, apparatuses, and articles of aspect 1, may provide for the reservation/priority information including one or more bandwidth reservation messages to reserve respective communication resources of the network node for wireless communication as the vehicle travels the route.

Aspect 3. The methods, apparatuses, and articles of aspect 2, may provide for the one or more bandwidth reservation messages including at least one of an indication of an amount of bandwidth reserved, information identifying the vehicle, information identifying the wireless communication device, information identifying a communication device other than the wireless communication device associated with the vehicle, information identifying an application that is active or desired to become active in association with the vehicle traveling the route, information regarding a bandwidth reservation start time, information regarding a bandwidth reservation end time, or any combination thereof.

Aspect 4. The methods, apparatuses, and articles of any of aspects 1-3, may provide for the reservation/priority information including one or more communication resource priority messages to establish communication priority, for respective communication resources of the network node, to wireless communication associated with the vehicle as the vehicle travels the route.

Aspect 5. The methods, apparatuses, and articles of aspect 4, may provide for the one or more communication resource priority messages including at least one of uplink priority information, downlink priority information, information identifying the vehicle, information identifying the wireless communication device, information identifying a communication device other than the wireless communication device associated with the vehicle, information identifying an application that is active or desired to become active in association with the vehicle traveling the route, or any combination thereof.

Aspect 6. The methods, apparatuses, and articles of any of aspects 4 and 5, may provide for receiving, in association with transmission of a communication resource priority message of the one or more communication resource priority messages, a response message indicating the network node is oversubscribed with respect to communication resource priority grants having communication priority higher than the communication priority to be established according to the one or more communication resource priority messages, and altering, in association with receiving the response message, an aspect of the route in correspondence with the radio map.

Aspect 7. The methods, apparatuses, and articles of any of aspects 1-6, may provide for identifying a portion of the roadway areas of the region associated with the plurality of network nodes traversed by the route having one or more undesirable communication attribute with respect to communication of HD map information, and transmitting HD map communication information associated with one or more roadway of the portion of roadway areas for transmission, the HD map communication information coordinating communication of one or more portions of HD map information, by a first network node of the plurality of network nodes associated with one or more roadway of the roadway areas traversed by the route prior to the portion of the roadway areas and having one or more desirable communication attribute with respect to communication of HD map information, to the wireless communication device as the vehicle travels the route.

Aspect 8. The methods, apparatuses, and articles of aspect 7, may provide for the reservation/priority information including one or more bandwidth reservation messages to reserve respective communication resources of the first network node for wireless communication of the HD map information as the vehicle travels the route.

Aspect 9. The methods, apparatuses, and articles of any of aspects 7 or 8, may provide for the HD map communication information coordinating communication of at least one portion of the one or more portions of HD map information by the first network node in correspondence with vehicular traffic congestion on the roadway.

Aspect 10. The methods, apparatuses, and articles of any of aspects 1-9, may provide for transmitting updated reservation/priority information, the updated reservation/priority information revised in association with vehicular traffic congestion information corresponding to the roadway areas traversed by the route.

Aspect 11. The methods, apparatuses, and articles of any of aspects 1-10, may provide for the routing request message including starting location information, destination information, and information regarding application utilization associated with traveling a route of the one or more communication-aware routes, the one or more communication-aware routes configured in correspondence to the information regarding application utilization.

Aspect 12. The methods, apparatuses, and articles of aspect 11, may provide for the information regarding application utilization including at least one of information regarding one or more applications currently active or desired to become active in association with use by one or more passenger devices of a vehicle to travel the route, one or more applications currently active or desired to become active in association with use by the vehicle to travel the route, or any combination thereof.

Aspect 13. The methods, apparatuses, and articles of any of aspects 11 or 12, may provide for the information regarding application utilization including one or more communication metrics including at least one of an application communication metric regarding one or more applications currently active or desired to become active during a time in which the vehicle travels the route, an uplink communication metric regarding an uplink to be provided with respect to the vehicle when traveling the route, a downlink communication metric regarding a downlink to be provided with respect to the vehicle when traveling the route, or any combination thereof.

Aspect 14. The methods, apparatuses, and articles of any of aspects 1-13, may provide for transmitting, to the wireless communication device in association with receiving the routing request message, information regarding the one or more communication-aware routes, the information regarding the one or more communication-aware routes including at least one of information regarding an average communication rate along the route, information regarding a road segment along the route having one or more undesirable communication attribute, information regarding one or more applications to be enabled along the route, or any combination thereof.

Aspect 15. Methods, apparatuses, and articles for wireless communication may provide for transmitting, to a routing system, a routing request message for one or more communication-aware routes associated with a radio map for roadway areas of a region associated with a plurality of network nodes, the routing request message including information regarding application utilization associated with traveling a route of the one or more communication-aware routes, and receiving the one or more communication-aware routes for a vehicle to travel the route.

Aspect 16. The methods, apparatuses, and articles of aspect 15, may provide for the information regarding application utilization including at least one of information regarding one or more applications currently active or desired to become active in association with use by one or more passenger devices of the vehicle, one or more applications currently active or desired to become active in association with use by the vehicle, or any combination thereof.

Aspect 17. The methods, apparatuses, and articles of any of aspects 15 or 16, may provide for the information regarding application utilization including one or more communication metrics, the one or more communication metrics including at least one of an application communication metric regarding one or more applications currently active or desired to become active during a time in which the vehicle travels the route, an uplink communication metric regarding an uplink to be provided in association with the vehicle when traveling the route, a downlink communication metric regarding a downlink to be provided in association with the vehicle when traveling the route, or any combination thereof.

Aspect 18. The methods, apparatuses, and articles of aspect 17, may provide for operating as an intermediary device of a plurality of devices associated with the vehicle, detecting devices of the plurality of devices as being associated with the vehicle, and providing the one or more communication metrics for the plurality of devices.

Aspect 19. The methods, apparatuses, and articles of any of aspects 17 or 18, may provide for updating at least one communication metric of the one or more communication metrics in association with a change in application utilization associated with traveling the route.

Aspect 20. The methods, apparatuses, and articles of any of aspects 15-19, may provide for the routing request message also including information regarding a passenger device other than the wireless communication device associated with the vehicle.

Aspect 21. The methods, apparatuses, and articles of any of aspects 15-20, may provide for the routing request message also including information of a preference regarding an aspect of a user trip experience associated with the vehicle when traveling the route.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1, 2, 3, 8, 9, 10 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A system comprising:
a processing system that includes one or more processors and one or more memories coupled with the one or more processors, the processing system configured to cause the system to:
receive, from a wireless communication device, a routing request message for one or more communication-aware routes associated with a radio map for roadway areas of a region associated with a plurality of network nodes;
generate, in association with receiving the routing request message, the one or more communication-aware routes for a vehicle associated with the wireless communication device to travel a route of the one or more communication-aware routes; and
transmit, in association with receiving the routing request message, reservation/priority information regarding communication resources of a network node of the plurality of network nodes, the network node associated with at least one roadway within the region corresponding to the route.

2. The system of claim 1, wherein the reservation/priority information includes one or more bandwidth reservation messages to reserve respective communication resources of the network node for wireless communication as the vehicle travels the route.

3. The system of claim 2, wherein the one or more bandwidth reservation messages include at least one of an indication of an amount of bandwidth reserved, information identifying the vehicle, information identifying the wireless communication device, information identifying a communication device other than the wireless communication device associated with the vehicle, information identifying an application that is active or desired to become active in association with the vehicle traveling the route, information regarding a bandwidth reservation start time, information regarding a bandwidth reservation end time, or any combination thereof.

4. The system of claim 1, wherein the reservation/priority information includes one or more communication resource priority messages to establish communication priority, for respective communication resources of the network node, to wireless communication associated with the vehicle as the vehicle travels the route.

5. The system of claim 4, wherein the one or more communication resource priority messages include at least one of uplink priority information, downlink priority information, information identifying the vehicle, information identifying the wireless communication device, information identifying a communication device other than the wireless communication device associated with the vehicle, information identifying an application that is active or desired to become active in association with the vehicle traveling the route, or any combination thereof.

6. The system of claim 4, wherein the processing system is configured to cause the system to:
receive, in association with transmission of a communication resource priority message of the one or more communication resource priority messages, a response message indicating the network node is oversubscribed with respect to communication resource priority grants having communication priority higher than the communication priority to be established according to the one or more communication resource priority messages; and
alter, in association with receiving the response message, an aspect of the route in correspondence with the radio map.

7. The system of claim 1, wherein the processing system is configured to cause the system to:
identify a portion of the roadway areas of the region associated with the plurality of network nodes traversed by the route having one or more undesirable communication attribute with respect to communication of high definition (HD) map information; and
transmit HD map communication information associated with one or more roadway of the portion of roadway areas for transmission, the HD map communication information coordinating communication of one or more portions of HD map information, by a first network node of the plurality of network nodes associated with one or more roadway of the roadway areas traversed by the route prior to the portion of the roadway areas and having one or more desirable communication attribute with respect to communication of HD map information, to the wireless communication device as the vehicle travels the route.

8. The system of claim 7, wherein the reservation/priority information includes one or more bandwidth reservation messages to reserve respective communication resources of the first network node for wireless communication of the HD map information as the vehicle travels the route.

9. The system of claim 7, wherein the HD map communication information coordinates communication of at least one portion of the one or more portions of HD map information by the first network node in correspondence with vehicular traffic congestion on the roadway.

10. They system of claim 1, wherein the processing system is configured to cause the system to:
transmit updated reservation/priority information, the updated reservation/priority information revised in association with vehicular traffic congestion information corresponding to the roadway areas traversed by the route.

11. The system of claim 1, wherein the routing request message includes starting location information, destination information, and information regarding application utilization associated with traveling a route of the one or more communication-aware routes, the one or more communication-aware routes configured in correspondence to the information regarding application utilization.

12. The system of claim 11, wherein the information regarding application utilization includes at least one of information regarding one or more applications currently active or desired to become active in association with use by one or more passenger devices of a vehicle to travel the route, one or more applications currently active or desired to become active in association with use by the vehicle to travel the route, or any combination thereof.

13. The system of claim 11, wherein the information regarding application utilization includes one or more communication metrics including at least one of an application communication metric regarding one or more applications currently active or desired to become active during a time in which the vehicle travels the route, an uplink communication metric regarding an uplink to be provided with respect to the vehicle when traveling the route, a downlink communication metric regarding a downlink to be provided with respect to the vehicle when traveling the route, or any combination thereof.

14. The system of claim 1, wherein the processing system is configured to cause the system to:
transmit, to the wireless communication device in association with receiving the routing request message, information regarding the one or more communication-aware routes, the information regarding the one or more communication-aware routes including at least one of information regarding an average communication rate along the route, information regarding a road segment along the route having one or more undesirable communication attribute, information regarding one or more applications to be enabled along the route, or any combination thereof.

15. An apparatus for wireless communication at a wireless communication device comprising:
a processing system that includes one or more processors and one or more memories coupled with the one or more processors, the processing system configured to cause the wireless communication device to:
transmit, to a routing system, a routing request message for one or more communication-aware routes associated with a radio map for roadway areas of a region associated with a plurality of network nodes, the routing request message including information regarding application utilization associated with traveling a route of the one or more communication-aware routes; and
receive the one or more communication-aware routes for a vehicle to travel the route.

16. The apparatus of claim 15, wherein the information regarding application utilization includes at least one of information regarding one or more applications currently active or desired to become active in association with use by one or more passenger devices of the vehicle, one or more applications currently active or desired to become active in association with use by the vehicle, or any combination thereof.

17. The apparatus of claim 15, wherein the information regarding application utilization includes one or more communication metrics, the one or more communication metrics including at least one of an application communication metric regarding one or more applications currently active or desired to become active during a time in which the vehicle travels the route, an uplink communication metric regarding an uplink to be provided in association with the vehicle when traveling the route, a downlink communication metric regarding a downlink to be provided in association with the vehicle when traveling the route, or any combination thereof.

18. The apparatus of claim 17, wherein the processing system is configured to cause the wireless communication device to:
operate as an intermediary device of a plurality of devices associated with the vehicle;
detect devices of the plurality of devices as being associated with the vehicle; and
provide the one or more communication metrics for the plurality of devices.

19. The apparatus of claim 17, wherein the processing system is configured to cause the wireless communication device to:
update at least one communication metric of the one or more communication metrics in association with a change in application utilization associated with traveling the route.

20. The apparatus of claim 15, wherein the routing request message also includes information regarding a passenger device other than the wireless communication device associated with the vehicle.

21-30. (canceled)
